(19) United States
(12) Patent Application Publication
(10) Pub. No.: US 2003/0198883 A1
(43) Pub. Date: Oct. 23, 2003

(54) Toner

(76) Inventors: Kaori Hiratsuka, Shizuoka (JP); Hirohide Tanikawa, Shizuoka (JP); Tsutomu Onuma, Kanagawa (JP); Nobuyuki Okubo, Shizuoka (JP)

Correspondence Address: FITZPATRICK CELLA HARPER & SCINTO, 30 ROCKEFELLER PLAZA, NEW YORK, NY, 10112, US

(21) Appl. No.: 10/409,192

(22) Filed: Apr. 9, 2003

(30) Foreign Application Priority Data
Apr. 10, 2002 (JP) 107260/2002

(51) Int. Cl. G03G 9/087

(52) U.S. Cl. 430/109.3; 430/109.2; 430/108.4; 430/108.8

(57) ABSTRACT

A toner is composed of toner particles containing a binder resin and hydrocarbon wax wherein the binder resin includes a vinyl resin having carboxyl and a vinyl resin having as a partial structure a linkage formed by the reaction of carboxyl with epoxy. Each of the acid value of tetrahydrofuran-soluble matter of the toner, the acid value of the binder resin and the hydroxyl value of the hydrocarbon wax is in a specific range, and the acid value of the binder resin and the hydroxyl value of the hydrocarbon wax fulfill a specific relationship.

### BACKGROUND OF THE INVENTION

1. Field of the Invention

This invention relates to a toner used in recording processes such as electrophotography, electrostatic recording, magnetic recording and toner jet recording.

2. Related Background Art

In electrophotographic processes in which copies or prints are commonly obtained by utilizing a photoconductive material and by forming an electrostatic latent image on a photosensitive member by various means, subsequently developing the electrostatic latent image by the use of a toner to form a toner image, and transferring the toner image to a transfer material such as paper as occasion calls, followed by fixing by the action of heat, pressure, heat-and-pressure or solvent vapor, various methods and apparatus are brought forth in regard to the step of fixing toner images to sheets such as paper. As typical ones, a pressure-and-heating system making use of a heating roller and also a heat fixing method in which transfer sheets with toner images (image-fixing sheets) are brought into close contact with a heating element via a film by means of a pressure member are proposed in a large number.

In such methods of heat fixing via a heating roller or film, the fixing is performed by passing an image-fixing sheet while bringing surfaces of toner images held on the sheet, into contact with the surface of a heating roller or film whose surface is formed of a material having a releasability to toner. This method shows a very good heat efficiency when toner images are melt-fixed to the image-fixing sheet surface, because the surface of the heating roller or film and the toner images on the image-fixing sheet come into contact. Thus, this method can perform fixing rapidly, and is very effective in electrophotographic copying machines or printers. However, in the above method, the toner images come into contact with the heating roller or film in a molten state. Hence, part of the toner images may adhere and transfer to the surface of the heating (fixing) roller or film, and this may retransfer to the next image-fixing sheet to cause an offset phenomenon to contaminate the image-fixing sheet. For this reason, it is regarded as one of important conditions of such a heat fixing method that the toner is made not to adhere to the surface of the fixing roller or film.

Accordingly, from an idea that an offset-preventive liquid be fed from the interiors of toner particles at the time of heating, a method has been proposed in which a release agent such as low-molecular-weight polyethylene or low-molecular-weight polypropylene is added to toner particles. However, adding such an additive in a large quantity in order to bring out a sufficient effect may cause filming to the photosensitive member or contamination of toner-carrying members such as a carrier and a developing sleeve to cause deterioration in image quality.

Japanese Patent Applications Laid-open No. 63-113558, No. 63-188158, No. 2-134648, No. 4-97162 and No. 4-97163 disclose techniques of incorporating an alcohol component in toner particles. The alcohol component can have the effect of improving anti-offset properties of toners, but may lower developing performance of toners.

Waxes having a polarity are also used in order to add to toners waxes having a polarity different from that of materials of various members, to improve releasability of toners from members such as fixing rollers at the time of fixing. Japanese Patent Application Laid-open No. 1-109359 discloses a technique of incorporating a low-molecular-weight polyolefin type polyol in toner particles. Such a wax is effective for the releasability of toners, but may make anti-blocking properties and high-temperature anti-offset properties insufficient.

Japanese Patent Applications Laid-open No. 4-184350, No. 4-194946, No. 4-194947 and No. 4-194948 disclose techniques of incorporating a polyglycerol partially esterified compound in toner particles. Even the addition of such a polyglycerol compound has not yet realized any sufficient fixing performance and anti-offset properties when used in high-speed machines.

The above proposals are effective in respect of improvement in fixing performance and anti-offset properties. However, performance has still been unsatisfactory when used in high-speed machines.

Japanese Patent Application Laid-open No. 2002-55477 (US-2002/34702-A) also discloses a toner containing a wax having a hydroxyl value of from 5 to 150 mg·KOH/g and an ester value of from 1 to 50 mg·KOH/g.

Meanwhile, as other methods for improving fixing performance and anti-offset properties, it is variously attempted to improve binder resins.

For example, in order to prevent offset, a method is also known in which the glass transition temperature (Tg) and molecular weight of a binder resin in toner are made higher to improve the melt viscoelasticity of the toner. However, where such a method is used to improve anti-offset properties, though not so affects developing performance, it may make fixing performance insufficient, and tends to cause, a problem especially when used in high-speed machines or when low-temperature fixing is performed.

In order to improve the low-temperature fixing performance of toners, it is necessary to decrease the viscosity of toner at the time of its melting and increase the contact area with a fixing member. For this reason, it is required to lower the Tg and molecular weight of binder resins used.

More specifically, the low-temperature fixing performance and the anti-offset properties conflict with each other in some phase, and hence it is very difficult to provide toners satisfying these performances at the same time.

To solve this problem, for example, Japanese Patent Publication No. 51-23354 discloses a toner comprising a vinyl polymer cross-linked to an appropriate degree by adding a cross-linking agent and a molecular weight modifier. Also proposed in a large number are toners of a blend type comprising a vinyl polymer in which its Tg, molecular weight and gel content are specified in combination.

Japanese Patent Applications Laid-open No. 61-110155 and No. 61-110156 also disclose that a binder having as essential constituent units a vinyl resin monomer and a special monoester compound is allowed to react with a polyvalent metal compound to carry out cross-linking through a metal.

Such toners containing a cross-linked vinyl polymer or a gel content have an excellent effect on anti-offset properties. However, where such a cross-linked vinyl polymer is used as a toner material, the polymer may have a very great internal friction in the step of melt kneading when the toner is produced, and a large shear force is applied to the polymer. Hence, in many cases, the cutting of molecular chains occurs to cause a decrease in melt viscosity, and this may adversely affect the anti-offset properties. Also, the melt viscosity increases greatly with an increase in gel content, and hence it becomes difficult to disperse additives such as carbon black, wax and a charge control agent in the toner particles, resulting in a lowering of toner characteristics.

Accordingly, to solve this problem, it is proposed as disclosed in Japanese Patent Applications Laid-open No. 55-90509, No. 57-178249, No., 57-178250 and No. 60-4946 that a resin having a carboxylic acid and a metal compound are used as toner materials and are heated and reacted at the time of melt kneading to form a cross-linked polymer, which is then incorporated into the toner. However, where such a cross-linked product is formed by this method, any slight difference in kneading conditions tends to cause great variations in quantity of the cross-linked product, and it is difficult to obtain the cross-linked product in a quantity appropriate for achieving the intended performance.

In addition, in order to obtain a binder resin effective for both anti-offset properties and fixing performance, proposals are also made as in the following. For example, as disclosed in Japanese Patent Applications Laid-open No. 3-63661, No. 3-63662, No. 3-63663 and No. 3-118552, a binder resin is proposed which is obtained by allowing a carboxyl-group-containing vinyl copolymer and a glycidyl-group-containing vinyl copolymer to react with a metal compound. Japanese Patent Applications Laid-open No. 7-225491 and No. 8-44107 still also disclose a binder resin obtained by allowing a carboxyl-group-containing resin to react with an epoxy resin to form a cross-linked structure. Then, Japanese Patent Applications Laid-open No. 62-194260, No. 6-11890, No. 6-222612, No. 7-20654, No. 9-185182, No. 9-244295, No. 9-319410, No. 10-87837 and No. 10-90943 disclose toner binder resins or toners in which molecular weight distribution, gel content, acid value and epoxy value are controlled in a resin composition constituted of a glycidyl-group-containing resin and a carboxyl-group-containing resin, to improve fixing performance and anti-offset properties.

As also disclosed in Japanese Patent Application Laid-open No. 2001-188383, a toner is proposed which contains a binder resin comprised of a carboxyl-group-containing resin and a glycidyl-group-containing resin and has peaks or shoulders in different two regions of molecular weight in molecular weight distribution measured by gel permeation chromatography of tetrahydrofuran-soluble matter in molecular weight distribution measured by gel permeation chromatography of tetrahydrofuran-soluble matter.

These proposals can improve the balance of fixing performance, anti-offset properties and anti-blocking properties. However, where toners are used in electrophotographic apparatus having a large print volume, it is sought to make further improvements in electrophotographic performance such as developing performance and fixing performance.

### SUMMARY OF THE INVENTION

An object of the present invention is to solve the above problems to provide a toner having superior developing running performance, fixing performance and anti-offset properties.

Another object of the present invention is to provide a toner which can achieve high image density without causing any blocking even when stored in a high-temperature environment.

Still another object of the present invention is to provide a toner which does not cause any toner melt adhesion to the toner-carrying member even in high-speed printing performed in a high-temperature environment.

That is, the present invention provides a toner having toner particles containing at least a binder resin and a hydrocarbon wax, wherein;

the binder resin contains at least a vinyl resin having a carboxyl group and a vinyl resin having as a partial structure a linkage formed by the reaction of a carboxyl group with an epoxy group;

the binder resin has an acid value (AV_{B}) of from 1 to 50 mg·KOH/g;

the hydrocarbon wax has a hydroxyl value (Hv) of from 5 to 150 mg·KOH/g; and

the acid value (AV_{B}) of the binder resin and the hydroxyl value (Hv) of the hydrocarbon wax satisfy the following expression:

0.05≦Av_{B}/Hv≦3.5.

### DETAILED DESCRIPTION OF THE PREFERRED EMBODIMENTS

In a toner containing at least a binder resin and a hydrocarbon wax, in virtue of the use of a binder resin having a carboxyl group and an epoxy group or a binder resin containing a structure formed by the reaction of these functional groups and also the use of a hydrocarbon wax having a hydroxyl group, the wax can be kept from being liberated from toner particles and also the toner can be improved in low-temperature fixing performance and anti-offset properties.

In the present invention, the hydrocarbon wax having a hydroxyl group has high affinity for the binder resin having as a partial structure a linkage formed by the reaction of a carboxyl group with an epoxy group, and can enjoy good dispersibility. Hence, even where the wax is added to the binder resin in a sufficient quantity, the blooming (oozing) of wax can not easily occur, and, even where the toner is left for a long term in a high-temperature environment, it would hardly cause what is called a blocking phenomenon in which the toner agglomerates. Also where images are formed in a high-temperature environment tending to cause in-machine temperature rise, the toner would hardly melt-adhere to the toner-carrying member (developing sleeve). On the other hand, since the wax stands dispersed in the toner particles in a good state, at the time of heat-fixing, the wax can easily ooze out to the toner particle surfaces and can provide the toner with a high releasability. Hence, an improvement in low-temperature fixing performance and anti-offset properties can be achieved. Thus, the toner of the present invention is desirably applicable also to high-speed machines.

In the present invention, in molecular weight distribution measured by gel permeation chromatography (GPC) of tetrahydrofuran(THF)-soluble matter of the toner, the toner has a number-average molecular weight of preferably from 1,000 to 40,000, more preferably from 2,000 to 20,000, and particularly preferably from 3,000 to 15,000, and a weight-average molecular weight of preferably from 10,000 to 10,000,000, more preferably from 20,000 to 5,000,000, and particularly preferably from 30,000 to 1,000,000.

When the toner has the above average molecular weight in its molecular weight distribution measured by GPC of THF-soluble matter, its fixing performance, anti-offset properties and anti-blocking properties can be balanced. Also, the toner can retain proper charge quantity and toughness, so that good developing performance and running (extensive operation) performance can be achieved.

If the toner has a number-average molecular weight of less than 1,000 or a weight-average molecular weight of less than 10,000 in its molecular weight distribution measured by GPC of THF-soluble matter, the toner may have so low melt viscosity as to tend to have inferior anti-blocking properties. If the toner has a number-average molecular weight of more than 40,000 or a weight-average molecular weight of more than 10,000,000, a high-molecular-weight component and a low-molecular-weight component in the binder resin may have low compatibility with each other to tend to make it difficult to achieve satisfactory fixing performance.

In the present invention, in molecular weight distribution measured by GPC of THF-soluble matter in the toner, the toner may also preferably have a main peak in the region of molecular weight of from 4,000 to 30,000, and may more preferably have a main peak in the region of molecular weight of from 5,000 to 20,000.

If the toner has a main peak in the region of molecular weight of less than 4,000, the toner may have so low melt viscosity that materials may poorly be dispersed in toner particles, tending to result in non-uniform charge distribution, so that developing performance and running performance may lower, e.g., fog and so forth may greatly occur. If on the other hand it has a main peak in the region of molecular weight of more than 30,000, good fixing performance may be achieved with difficulty.

The resin component (binder resin) of the toner of the present invention may also preferably contain a THF-insoluble matter in an amount of from 0.1 to 60% by weight, more preferably from 5 to 60% by weight, and particularly preferably from 10 to 45% by weight. When it contains the THF-insoluble matter within the above range, materials can uniformly be dispersed in toner particles, and good developing performance and running performance can be achieved.

If the THF-insoluble matter is more than 60% by weight, materials may poorly be dispersed in toner particles to tend to become non-uniformly chargeable, and hence the developing performance may lower to cause fog and so forth. The dispersibility of the wax may also lower, and hence any liberated wax component may cause contamination of members with which the toner comes into contact.

The toner of the present invention has THF-soluble matter preferably having an acid value (AV_{T}) of from 1 to 50 mg·KOH/g, more preferably from 1 to 40 mg·KOH/g, and particularly preferably from 2 to 30 mg·KOH/g. If the toner has THF-soluble matter having an acid value of less than 1 mg·KOH/g, the toner may have a low charge quantity, resulting in a lowering of developing performance. If on the other hand, the acid value is more than 50 mg·KOH/g, the toner may have a high hygroscopicity, resulting in a lowering of developing power in a high-temperature and high-humidity environment. Also from the viewpoint of mutual action of the wax used in the present invention as will be detailed later, it is preferable for the THF-soluble matter in the toner to have the acid value of from 1 to 50 mg·KOH/g.

In the present invention, the toner contains “vinyl resin having a carboxyl group” and “vinyl resin having as a partial structure a linkage formed by the reaction of a carboxyl group with an epoxy group” as the binder resin.

The “vinyl resin having as a partial structure a linkage formed by the reaction of a carboxyl group with an epoxy group” may preferably be a resin formed by combination of the carboxyl group with the epoxy group in a vinyl resin having a carboxyl group and a vinyl resin having an epoxy group, or a resin formed by combination of the carboxyl group with the epoxy group in a vinyl resin having a carboxyl group and an epoxy group. Of these, the former is more preferred.

Referring to the “linkage formed by the reaction of a carboxyl group with an epoxy group” e.g., when a compound having a glycidyl group as the epoxy group is used, a cross-linked structure is formed according to the following reaction.

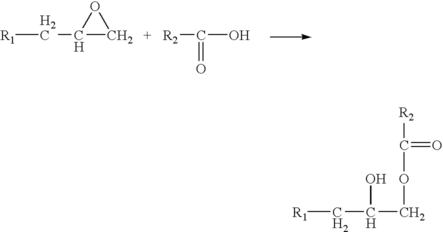

Monomers having a carboxyl group which are usable in order to obtain the “vinyl resin having a carboxyl group” and “vinyl resin having as a partial structure a linkage formed by the reaction of a carboxyl group with an epoxy group” according to the present invention may include the following: for example, unsaturated monocarboxylic acids such as acrylic acid, methacrylic acid, α-ethylacrylic acid, crotonic acid, cinnamic acid, vinylacetic acid, isocrotonic acid, tiglic acid and angelic acid; α- or β-alkyl derivatives of these unsaturated monocarboxylic acids; unsaturated dicarboxylic acids such as fumaric acid, maleic acid, citraconic acid, alkenylsuccinic acids, itaconic acid, mesaconic acid, dimethylmaleic acid and dimethylfumaric acid; and monoester derivatives, anhydrides and α- or β-alkyl derivatives of these unsaturated dicarboxylic acids. Any of these monomers having a carboxyl group may be used alone or in the form of a mixture, or may be used in the form of a copolymer copolymerized with other vinyl monomers by a known polymerization method.

The “vinyl resin having a carboxyl group” usable when obtaining the “vinyl resin having as a partial structure a linkage formed by the reaction of a carboxyl group with an epoxy group” may preferably have an acid value of from 1.0 to 60 mg·KOH/g, more preferably from 1.0 to 50 mg·KOH/g, and still more preferably from 2.0 to 40 mg·KOH/g. If it has an acid value of less than 1.0 mg·KOH/g, the sites at which the carboxyl group and the glycidyl group undergo cross-linking reaction are so reduced that the cross-linked structure may not sufficiently by developed, making it difficult to satisfactorily achieve the improvement in running performance of the toner. In such a case, a vinyl resin having a glycidyl group with a high epoxy value may be used to make the cross-link density higher to a certain degree. However, any residual epoxy groups may affect developing performance or the cross-linked structure may be controlled with difficulty. If it has an acid value of more than 60 mg·KOH/g, the toner particles may have a high hygroscopicity to tend to cause a decrease in image density and an increase in fog.

The “vinyl resin having a carboxyl group” usable when obtaining the “vinyl resin having as a partial structure a linkage formed by the reaction of a carboxyl group with an epoxy group” according to the present invention, may preferably have a number-average molecular weight of from 1,000 to 40,000 in order to achieve good fixing performance and developing performance, and may preferably have a weight-average molecular weight of from 10,000 to 10,000,000 in order to achieve good anti-offset properties, anti-blocking properties and running performance.

The “vinyl resin having a carboxyl group” usable when obtaining the “vinyl resin having as a partial structure a linkage formed by the reaction of a carboxyl group with an epoxy group” according to the present invention may preferably contain a low-molecular-weight component and a high-molecular-weight component. The low-molecular-weight component may preferably have a main peak molecular weight of from 4,000 to 30,000, and more preferably from 5,000 to 25,000, in order to achieve good fixing performance. The high-molecular-weight component may preferably have a main peak molecular weight of from 10,000 to 1,000,000, and more preferably from 100,000 to. 500,000, in order to achieve good anti-offset properties, anti-blocking properties and running performance.

In the “vinyl resin having a carboxyl group” usable when obtaining the “vinyl resin having as a partial structure a linkage formed by the reaction of a carboxyl group with an epoxy group”, the low-molecular-weight component and the high-molecular-weight may be used in a proportion of low-molecular-weight component high-molecular-weight=95:5 to 50:50, and preferably 90:1 to 55:45. This is preferable in view of fixing performance and dispersibility of other additives such as wax.

A synthesis method by which the “vinyl resin having a carboxyl group” is obtainable may include bulk polymerization, solution polymerization, emulsion polymerization and suspension polymerization.

Of these, the emulsion polymerization is a method in which a monomer almost insoluble in water is dispersed with an emulsifying agent in an aqueous phase in the form of small particles to carry out polymerization in the presence of a water-soluble polymerization initiator. In this method, the phase where the polymerization is carried out (i.e., an oily phase formed of polymers and monomers) is separate from the aqueous phase and hence the termination reaction proceeds at a low rate, so that a product with a high polymerization degree can be obtained. Moreover, the reaction heat can be controlled with ease, the polymerization process is relatively simple, and the polymerization product is in the form of fine particles. Hence, the product can readily be mixed with a colorant, a charge control agent and other additives when the toner is produced. Thus, this has an advantage as a production process of binder resins for toners.

However, the polymer tends to become impure because of the emulsifying agent added, and operation such as salting-out is required in order to take out the polymer. To avoid this disadvantage, suspension polymerization is advantageous.

In the suspension polymerization, the reaction may preferably be carried out using a polymerizable monomer in an amount of 100 parts by weight or less, and preferably from 10 to 90 parts by weight, based on 100 parts by weight of the aqueous medium. As a usable solvent, it may include polyvinyl alcohol, partially saponified polyvinyl alcohol, and calcium phosphate, any of which may usually be used in an amount of from 0.05 to 1 part by weight based on 100 parts by weight of the aqueous medium. Polymerization temperature may be from 50° C. to 95° C. as a suitable range, and may appropriately be selected depending on the initiator used and the intended polymer.

In order to achieve the object of the present invention, when producing the high-molecular-weight component of the “vinyl resin having a carboxyl group”, a polyfunctional polymerization initiator as exemplified below may preferably be used as a polymerization initiator.

As specific examples of a polyfunctional polymerization initiator having a polyfunctional structure, it may include polyfunctional polymerization initiators having in one molecule two or more functional groups such as peroxide groups, having a polymerization initiating function, as exemplified by 1,1-di-t-butylperoxy-3,3,5-trimethylcyclohexane, 1,3-bis(t-butylperoxyisopropyl)benzene, 2,5-dimethyl-2,5-(t-butylperoxy)hexane, 2,5-dimethyl-2,5-di-(t-butylperoxy)hexane, tris-(t-butylperoxy)triazine, 1,1-di-t-butylperoxycyclohexane, 2,2-di-t-butylperoxybutane, 4,4-di-t-butylperoxyvaleric acid-n-butyl ester, di-t-butyl peroxyhexahydroterephthalate, di-t-butyl peroxyazelate, di-t-butyl peroxytrimethyladipate, 2,2-bis(4,4-di-t-butylperoxycyclohexyl)propane, 2,2-di-t-butylperoxyoctane, and various polymer oxides; and polyfunctional polymerization initiators having in one molecule both a functional group such as a peroxide group, having a polymerization initiating function, and a polymerizable unsaturated group, as exemplified by diallyl peroxydicarbonate, t-butyl peroxymaleate, t-butylperoxyallyl carbonate, and t-butylperoxyisopropyl fumarate.

Of these, more preferred ones are 1,1-di-t-butylperoxy-3,3,5-trimethylcyclohexane, 1,1-di-t-butylperoxycyclohexane, di-t-butyl peroxyhexahydroterephthalate, di-t-butyl peroxyazelate, 2,2-bis(4,4-di-t-butylperoxycyclohexyl)propane, and t-butylperoxyallyl carbonate.

In order to satisfy various performances required as binders for the toner, any of these polyfunctional polymerization initiators may preferably be used in combination with a monofunctional polymerization initiator. In particular, they may preferably be used in combination with a polymerization initiator having decomposition temperature which is lower than the decomposition temperature of the polyfunctional polymerization initiator, with regard to decomposition temperature for obtaining a half-life of 10 hours.

Such a monofunctional polymerization initiator may specifically include organic peroxides such as benzoylperoxide, 1,1-di(t-butylperoxy)-3,3,5-trimethylcyclohexane, n-butyl-4,4-di(t-butylperoxy)valerate, dicumyl peroxide, 2,2-bis(t-butylperoxydiisopropyl)benzene, t-butylperoxycumene, and di-t-butyl peroxide; and azo or diazo compounds such as azobisisobutylonitrile and diazoaminoazobenzene.

Any of these monofunctional polymerization initiators may be added to the monomer at the same time the polyfunctional polymerization initiator is added. In order to keep a proper efficiency of the polyfunctional polymerization initiator, the monofunctional polymerization initiator may preferably be added after the half-life the polyfunctional polymerization initiator shows has lapsed in the polymerization step.

Any of these polymerization initiators may preferably be added in an amount of 0.01 to 10 parts by weight based on 100 parts by weight of the polymerizable monomer, in view of efficiency.

As methods for synthesizing the low-molecular-weight component of the “vinyl resin having a carboxyl group” usable when obtaining the “vinyl resin having as a partial structure a linkage formed by the reaction of a carboxyl group with an epoxy group”, known methods may be used. In bulk polymerization, polymers with a low-molecular weight can be obtained by polymerizing the monomer at a high temperature and accelerating the rate of termination reaction, but there is the problem of difficulty in controlling the reaction. In this regard, in solution polymerization, low-molecular weight polymers can be obtained with ease under mild conditions, utilizing a difference in chain transfer of radicals that is caused by solvent, and controlling the quantity of initiators and the reaction temperature. Thus, this method is preferred in order to obtain the low-molecular weight component in the vinyl resin having a carboxyl group.

As the solvent used in the solution polymerization, xylene, toluene, cumene, cellosolve acetate, isopropyl alcohol or benzene may be used. Where a styrene monomer is used as the polymerizable monomer, xylene, toluene or cumene is preferred. The solvent may appropriately be selected depending on the monomer to be polymerized and the polymer to be produced. As to reaction temperature, which may differ depending on the solvent and polymerization initiator to be used and the polymer to be produced, the reaction may be carried out usually at 70° C. to 230° C. In the solution polymerization, the monomer may preferably be used in an amount of from 30 to 400 parts by weight based on 100 parts by weight of the solvent. It is also preferable to further mix another polymer in the solution when the polymerization is terminated. Several kinds of polymers may be mixed.

The “vinyl resin having an epoxy group” used when the “vinyl resin having as a partial structure a linkage formed by the reaction of a carboxyl group with an epoxy group” is described below. The epoxy group referred to herein means a functional group in which an oxygen atom is bonded to different carbon atoms in the same molecule, and has a cyclic ether structure.

As a monomer having an epoxy group that is usable in the present invention, it may include the following:

glycidyl acrylate, glycidyl methacrylate, β-methylglycidyl acrylate, β-methylglycidyl methacrylate, allyl glycidyl ether and allyl β-methylglycidyl ether. A glycidyl monomer represented by Formula (1) below may also preferably be used.

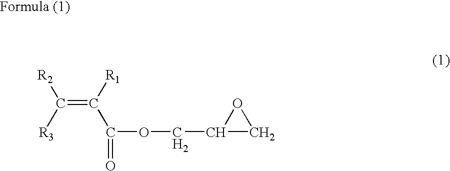

In Formula (1), R₁, R₂ and R₃ are each independently a hydrogen atom, or a group selected from the group consisting of an alkyl group, an aryl group, an aralkyl group, a carboxyl group or an alkoxycarbonyl group.

The monomers having such an epoxy group may be used alone or in combination to carry out polymerization, and may be copolymerized with other vinyl monomers by a known polymerization method to obtain the vinyl resin having an epoxy group.

The “vinyl resin having an epoxy group” usable when obtaining the binder resin according to the present invention may preferably have a weight-average molecular weight (Mw) of from 2,000 to 100,000, more preferably form 2,000 to 50,000, and still more preferably from 3,000 to 40,000. If it has the Mw less than 2,000, the binder resin tends to have an imperfectly cross-linked structure therein and a large number of molecules may be cut in the kneading step, resulting in low running performance. If it has the Mw higher than 100,000, it tends to lower fixing performance.

The epoxy value may preferably be from 0.05 to 5.0 eq/kg, and more preferably from 0.05 to 2.0 eq/kg. If it is less than 0.05 eq/kg, the cross-linking reaction may proceed with difficulty, and the high-molecular-weight component or THF-insoluble matter may be formed in a small quantity to make the toner have poor anti-offset properties and a low toughness. If it is higher than 5.0 eq/kg, the cross-linking reaction may proceed with ease, but on the other hand a large number of molecules may be cut in the kneading step, resulting in the halved effect on anti-offset properties.

In the “vinyl resin having an epoxy group” according to the present invention, the epoxy group may preferably be used in a mixing proportion of from 0.01 to 10.0 equivalent weight, and more preferably from 0.03 to 5.0 equivalent weight, based on 1 equivalent weight of the total carboxyl groups in the “vinyl resin having a carboxyl group” and “vinyl resin having a carboxyl group contained in the others” used when the “vinyl resin having as a partial structure a linkage formed by the reaction of a carboxyl group with an epoxy group” is obtained.

If the epoxy group is less than 0.01 equivalent weight, the cross-linking points may be so few in the binder resin that the effect attributable to cross-linking reaction, such as anti-offset properties, may be difficult to bring out. If it is more than 10 equivalent weight, the cross-linking reaction may easily take place, but on the other hand poor dispersion may result because of, e.g., the formation of excessive THF-insoluble matter, to cause poor pulverizability and a problem on, the stability of development.

In the “vinyl resin having an epoxy group”, the epoxy group may preferably be used in an amount of from 0.03 to 1 equivalent weight, and particularly preferably from 0.03 to 0.5 equivalent weight, based on 1 equivalent weight of the carboxyl group. Where the respective vinyl resins are so used that the epoxy group may come to less than 1 equivalent weight based on 1 equivalent weight of the carboxyl group, the vinyl resin having a carboxyl group comes to remain in the state that any cross-link with the epoxy group may not be formed, and hence the acid value desired as the binder resin and toner can be achieved with ease.

Where the vinyl resin having a carboxyl group and an epoxy group is used when the binder resin according to the present invention is obtained, it may preferably have a number-average molecular weight of from 10,000 to 40,000 in order to achieve good fixing performance, and may preferably have a weight-average molecular weight of from 10,000 to 10,000,000 in order to achieve good anti-offset properties and anti-blocking properties.

The vinyl resin having a carboxyl group and an epoxy group is obtained by mixing a monomer having a carboxyl group and a monomer having an epoxy group, and copolymerizing the mixture with other vinyl monomers by a known polymerization method.

As a means for obtaining the “vinyl resin having as a partial structure a linkage formed by the reaction of a carboxyl group with an epoxy group”, (1) the vinyl resin having a carboxyl group and the vinyl resin having an epoxy group may be mixed in the state of a solution, followed by heating in a reaction vessel to cause the cross-linking reaction to take place, or (2) the vinyl resin having a carboxyl group and the vinyl resin having an epoxy group may each be taken out of a reaction vessel, and may be dry-blended by means of a Henschel mixer or the like, followed by heat melt-kneading by means of a twin extruder or the like to allow the carboxyl group to react with the epoxy group to effect cross-linking. Also when the vinyl resin having a carboxyl group and an epoxy group is used, the heat melt-kneading may likewise carried out by means of a twin extruder or the like to allow the carboxyl group to react with the epoxy group to effect cross-linking.

In the present invention, the “vinyl resin having as a partial structure a linkage formed by the reaction of a carboxyl group with an epoxy group” may preferably contain from 0.1 to 60% by weight of THF-insoluble matter. In the case where the THF-insoluble matter is contained in the above range, the resin itself can have an appropriate melt viscosity, and hence uniform dispersion of materials can be achieved. If its THF-insoluble matter is more than 60% by weight, the resin itself may have so high melt viscosity as to tend to make poor the dispersion of materials.

The vinyl monomer copolymerizable with the monomer having a carboxyl group unit and, the monomer having an epoxy group unit may include the following:

styrene; styrene derivatives such as o-methylstyrene, m-methylstyrene, p-methylstyrene, p-methoxystyrene, p-phenylstyrene, p-chlorostyrene, 3,4-dichlorostyrene, p-ethylstyrenee, 2,4-dimethylstyrene, p-n-butylstyrene, p-tert-butylstyrene, p-n-hexylstyrene, p-n-octylstyrene, p-n-nonylstyrene, p-n-decylstyrene and p-n-dodecylstyrene; ethylene unsaturated monoolefins such as ethylene, propylene, butylene and isobutylene; unsaturated polyenes such as butadiene and isoprene; vinyl halides such as vinyl chloride, vinylidene chloride, vinyl bromide and vinyl fluoride; vinyl esters such as vinyl acetate, vinyl propionate and vinyl benzoate; α-methylene aliphatic monocarboxylates such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate; acrylic esters such as methyl acrylate, ethyl acrylate, n-butyl acrylate, isobutyl acrylate, propyl acrylate, 1-octyl acrylate, dodecyl acrylate, 2-ethylhexyl acrylate, stearyl acrylate, 2-chloroethyl acrylate and phenyl acrylate; vinyl ethers such as methyl vinyl ether, ethyl vinyl ether and isobutyl vinyl ether; vinyl ketones such as methyl vinyl ketone, hexyl vinyl ketone and methyl isopropenyl ketone; N-vinyl compounds such as N-vinylpyrrole, N-vinylcarbazole, N-vinylindole and N-vinylpyrrolidone; vinylnaphthalenes; and acrylic acid or methacrylic acid derivatives such as acrylonitrile, methacrylonitrile and acrylamide. Any of these vinyl monomers may be used alone or in a combination of two or more monomers.

Of these, monomers may preferably be used in such a combination that may give a styrene copolymer and a styrene-acrylic or -methacrylic copolymer. In this case, in view of fixing performance and mixing properties, such monomers may preferably contain at least 65% by weight of a styrene copolymer component or a styrene-acrylic or -methacrylic copolymer component.

The binder resin according to the present invention contains the vinyl resin having a carboxyl group. The binder resin according to the present invention contains the vinyl resin having a carboxyl group to have an acid value. Since the resin having a carboxyl group is the vinyl resin, good compatibility with the “vinyl resin having as a partial structure a linkage formed by the reaction of a carboxyl group with an epoxy group” is achievable. As the “vinyl resin having a carboxyl group” to be contained in the binder resin, the same resin as the vinyl resin used when the “vinyl resin having as a partial structure a linkage formed by the reaction of a carboxyl group with-an epoxy group” is produced, may be used.

In the binder resin according to the present invention, i) a vinyl resin having a carboxyl group, ii) a resin mixture of a vinyl resin having a carboxyl group and a vinyl resin having an epoxy group, or iii) a vinyl resin having a carboxyl group and an epoxy group may also be contained. As these vinyl resins, the same resins as the vinyl resins used when the “vinyl resin having as a partial structure a linkage formed by the reaction of a carboxyl group with an epoxy group” is produced, may be used.

The binder resin according to the present invention may preferably have an acid value of form 1 to 50 mg·KOH/g. The use of the binder resin having such an acid value enables the acid value of the THF-soluble matter in the toner to be adjusted within the desired range. This is also preferable in view of such an advantage that the electrostatic attraction force acting between the wax according to the present invention, having a hydroxyl group, and the binder resin can be made higher.

Besides the foregoing, the binder resin used in the toner of the present invention may also contain the following polymer.

For example, usable are homopolymers of styrene or styrene derivatives such as polystyrene, poly-p-chlorostyrene and polyvinyl toluene; styrene copolymers such as a styrene-p-chlorostyrene copolymer, a styrene-vinyltoluene copolymer, a styrene-vinylnaphthalene copolymer, a styrene-acrylate copolymer, a styrene-methacrylate copolymer, a styrene-methyl α-chloromethacrylate copolymer, a styrene-acrylonitrile copolymer, a styrene-methyl vinyl ether copolymer, a styrene-ethyl vinyl ether copolymer, a styrene-methyl vinyl ketone copolymer, a styrene-butadiene copolymer, a styrene-isoprene copolymer and a styrene-acrylonitrile-indene copolymer; polyvinyl chloride, phenolic resins, natural resin modified phenolic resins, natural resin modified maleic acid resins, acrylic resins, methacrylic resins, polyvinyl acetate, silicone resins, polyester resins, polyurethane resins, polyamide resins, furan resins, epoxy resins, xylene resins, polyvinyl butyral, terpene resins, cumarone indene resins, and petroleum resins. In the present invention, any of these optional-component resins may be contained in an amount of 30% by weight or less, and preferably 20% by weight or less, in the binder resin.

The hydrocarbon wax used in the present invention is described below.

The hydrocarbon wax used in the present invention is a hydrocarbon wax characterized by having a hydroxyl value of from 5 to 150 mg·KOH/g. It may preferably have a hydroxyl value of from 10 to 100 mg·KOH/g, and more preferably from 20 to 90 mg·KOH/g.

The present inventors presume that a hydrocarbon wax having an appropriate hydroxyl group in the molecule acts in the following way:

In the resin according to the present invention which has the moiety of cross-linked structure produced by the reaction of the carboxyl group with the epoxy group, the hydroxyl group of the wax and the moiety of cross-linked structure in the resin electrostatically attract each other, and hence the wax comes to enter the vicinity of a cross-linked structure moiety where molecular chains stand entangled with one another at a high degree, and acts so as to disentangle the mutual entanglement of molecular chains. Hence, in the present invention, it is considered that even such a toner having cross-linked structure can provide the toner particles with an appropriate plasticizing effect, which makes it feasible to obtain a toner having superior low-temperature fixing performance. Also, the wax is dispersed in an almost uniform state, and hence the wax may swiftly ooze out to toner particle surfaces when the wax melts at the time of heat fixing of the toner, improving low-temperature fixing performance and anti-offset properties. In addition, the wax is dispersed in the toner particles in a good state, and hence there is an advantage that the wax can be added in a large quantity. If the wax has a hydroxyl value of less than 5 mg·KOH/g, the effect of improving the dispersibility of wax can not sufficiently be obtained to make the toner have low fixing performance and anti-offset properties. If on the other hand the wax has a hydroxyl value of more than 150 mg·KOH/g, the wax may have too great plasticizing effect and make the toner have low anti-blocking properties.

The relationship between the hydroxyl value (Hv) of the hydrocarbon wax and the acid value (Av_{B}) of the binder resin is characterized by satisfying the following expression:

0.05≦Av_{B}/Hv≦3.5.

It may preferably satisfy:

0.1≦Av_{B}/Hv≦1.5, and more preferably satisfy:

0.1≦Av_{B}/Hv≦0.5.

The acid group the binder resin has and the hydroxyl group the wax has produce electrostatic attraction force in toner particles, and can keep the wax from being liberated from the toner particles. In virtue of this action, the toner can be kept from melt-adhering to the image-bearing member (photosensitive drum) and the developing sleeve, and these members can be kept from contamination. Also, when the wax and resin having the above hydroxyl value and acid value, respectively, are used in combination, the wax is more uniformly dispersed in the resin, which makes it feasible to make both the materials have high affinity without damaging chargeability in the whole toner.

If the proportion of the acid value of the binder resin to the hydroxyl value of the wax is less than 0.05, the wax and the resin may have low affinity to tend to cause the blooming of wax to toner particle surfaces and also tend to cause faulty charging. As the result, fog may conspicuously occur when images are formed. Also, because of the influence of the blooming of wax, the toner may melt-adhere onto the photosensitive member.

If on the other hand the proportion of the acid value of the binder resin to the hydroxyl value of the wax is more than 3.5, the wax may be dispersed in the resin with difficulty to come to be present in the toner in the state of large dispersion diameter. As the result, the toner tends to cause faulty charging after all, so that fog may conspicuously occur when images are formed, and also the wax dispersed in a large diameter is liable to be liberated from toner particle surfaces, tending to cause, e.g., melt-adhesion of toner to the photosensitive member.

When the proportion of the acid value of the binder resin to the hydroxyl value of the wax satisfy:

0.05×Hv≦Av_{B}≦3.5×Hv,

the wax and the resin can be made to have higher affinity, and hence faulty charging hardly occurs and also blooming of the wax from toner particles hardly occurs. Hence, the toner can be kept from melt-adhering to the photosensitive member surface, so that good images can be formed over a long period of time.

When the binder resin (vinyl resin) having as a partial structure a linkage formed by the reaction of a carboxyl group with an epoxy group is used in combination with the hydrocarbon wax having a hydroxyl group, the binder resin and the wax can have high affinity, and the wax can be incorporated in the binder resin in a large quantity as the good dispersion state is maintained. Thus, the plasticity of the wax can sufficiently be brought out, and hence superior low-temperature fixing performance can be achieved also in high-speed machines. Also, since the wax and the resin have high affinity, the wax blooming to toner particle surfaces does not occur even when the toner is long-term stored in a high-temperature and high-humidity environment, ensuring excellent anti-blocking properties. In addition, because of the liberation or elution of the wax and its plasticizing effect to the resin, the toner may adhere to the toner-carrying member (developing sleeve), so that the toner is inhibited from being charged, to cause image defects. Such a problem can be kept from arising when the binder resin and wax according to the present invention are used in combination.

The hydrocarbon wax according to the present invention may also preferably have an ester value of from 1 to 50 mg·KOH/g, more preferably from 1 to 30 mg·KOH/g, and still more preferably from 1 to 15 mg·KOH/g. Ester groups in the wax have so high affinity for the binder resin component of the toner that the wax can be better dispersed in toner particles, thereby effectively bringing out the action of the wax. If the wax has an ester value of less than 1 mg·KOH/g, the wax and the binder resin may insufficiently be improved in affinity, and the effect of the wax for the fixing performance and anti-offset properties of the toner may lower. If on the other hand the wax has an ester value of more than 50 mg·KOH/g, the wax may have too high affinity for the resin, resulting in a lowering of the release action the wax has, to make it difficult to achieve satisfactory anti-offset properties.

First of all, in the present invention, the binder resin has the cross-linked structure produced by the reaction of a carboxyl group with an epoxy group. Hence, an appropriate load is applied when toner materials are melt-kneaded, and materials such as the wax and others can be dispersed in the binder resin in a good state.

The hydrocarbon wax according to the present invention may preferably have an acid value (Av) of from 1 to 30 mg·KOH/g, more preferably from 1 to 15 mg·KOH/g, and still more preferably from 1 to 10 mg·KOH/g. Inasmuch as the wax has such an acid value, it can have a strong interfacial adhesion to other components included in the toner, enhancing the effect of the wax plasticizing the toner, so that the toner can-be improved in fixing performance. If the wax has an acid value of less than 1 mg·KOH/g, it may have a weak interfacial adhesion to other components included in the toner. Hence, the wax tends to become liberated from toner particles, and the action of the wax may insufficiently be brought out. If on the other hand the wax has an acid value of more than 1 mg·KOH/g, it may have too strong interfacial adhesion, so that the plasticization of the toner may greatly proceed to make it impossible to retain sufficient releasability.

In the hydrocarbon wax in the present invention, its hydroxyl value (Hv) and ester value (Ev) may preferably satisfy:

Hv>Ev.

They may further preferably satisfy the relationship of:

Hv>2×Ev.

More preferably, Hv/Ev=2.5 to 20.

In the hydrocarbon wax in the present invention, its acid value (Av) and hydroxyl value (Hv) may preferably satisfy:

Hv>Av.

They may further preferably satisfy the relationship of:

Hv>2×Av.

More preferably, Hv/Av=2.5 to 20.

The hydroxyl group the wax in the present invention has makes the toner have high slip characteristics, and hence can improve the releasability of toner from the fixing member. Also, as stated above, the ester groups of the wax has high affinity for the binder resin and acts to disperse the wax in toner particles in an almost uniform state. Hence, inasmuch as the wax has the ester group and the hydroxyl group simultaneously, it has superior slip characteristics and is present in toner particles in an almost very uniform state. Thus, the releasability of the toner in respect to (or from) the fixing member can stably be improved, and the offset phenomenon at the time of high-temperature fixing can be prevented from occurring.

If the ester value of the hydrocarbon wax is not less than the hydroxyl value thereof, the binder resin has so high affinity for the wax that it is difficult for the wax to ooze out to toner particle surfaces and to act as such, adversely affecting the fixing performance. On the other hand, since the ester group in the wax has high affinity for the binder resin component and the hydroxyl group has high affinity for image-fixing sheets such as paper, these bring out the effect of keeping the toner from adhering to the fixing member. As the result, the toner can achieve its releasability from the fixing member and its low-temperature fixing performance.

In addition, since the wax has the ester group and the hydroxyl group simultaneously, the wax can be dispersed with an appropriate diameter in toner particles, and the action of the wax can effectively be brought out. If either the acid group or the ester group is lacking, the diameters of the wax dispersed in toner particles may become so greatly non-uniform that the wax may not sufficiently act as such.

In the hydrocarbon wax used in the present invention, its backbone chain is composed of carbon-carbon bonds (i.e., a methylene chain), whereby substituents such as the acid group, the hydroxyl group and the ester group are made to easily function in toner particles, and fixing performance and anti-offset properties can be effectively improved. If other elements are contained in the backbone chain of the wax, e.g., if oxygen is contained in the backbone chain as in the case of polyglycerol, the action and effect of the wax may come small and further the function of the respective substituents characteristic of the present invention may be obstructed, making it difficult to achieve favorable fixing performance and anti-offset properties.

The hydrocarbon wax used in the present invention is one preferably containing a “molecular chain having a secondary alcohol structure having a hydroxyl group at the secondary carbon atom” represented by the following partial structural formula (A), or a “molecular chain having an ester structure having an ester linkage” represented by the following partial structural formula (B), and may have both structures in one molecule. It may also have a “molecular chain having a primary alcohol structure having a hydroxyl group at the primary carbon atom” represented by the following partial structural formula (E). Also preferable are those having in the wax “molecular chains each having a carboxyl group at the primary or secondary carbon atom” represented by the following partial structural formulas (C) and (D).

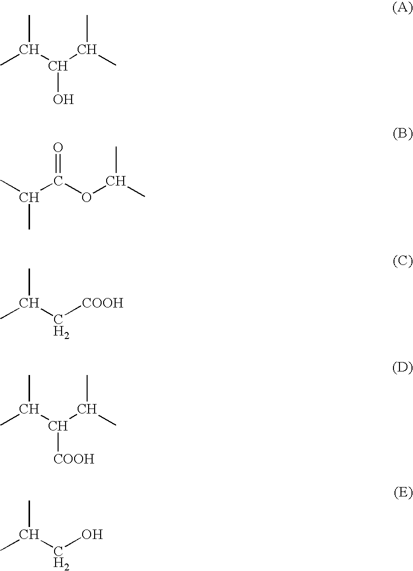

As a method for producing the hydrocarbon wax having a hydroxyl group, a carboxyl group or an ester group in the molecule as described above, a method is available in which, e.g., an aliphatic hydrocarbon is subjected to liquid-phase oxidation with a molecular-oxygen-containing gas in the presence of boric acid and boric anhydride. As a catalyst, a mixture of boric acid and boric anhydride may be used. The mixing ratio of the boric acid and the boric anhydride (boric acid/boric anhydride) may be in the range of from 1.0 to 2.0, and preferably from 1.2 to 1.7, in molar ratio. If the proportion of the boric anhydride is less than the above range, an excess portion of the boric acid may cause a phenomenon of agglomeration, undesirably. If on the other hand the proportion of the boric anhydride is more than the above range, powdery substance derived from the boric anhydride may be mixed in the wax component after the reaction. Also, the excess boric anhydride does not contribute to the reaction, and is undesirable also from the economical standpoint.

The boric acid and boric anhydride may be added in an amount, as converted to boric acid, of from 0.001 to 10 moles, and particularly preferably from 0.1 to 1.0 moles, based on 1 mole of the raw-material aliphatic hydrocarbon.

As the molecular-oxygen-containing gas blown into the reaction system, oxygen, air, or a vast range of gases formed by diluting any of these with an inert gas may be used, where the gas may preferably have an oxygen concentration of from 1 to 30% by volume, and more preferably from 3 to 20% by volume.

The liquid-phase oxidation is carried out in a molten state of the raw-material aliphatic hydrocarbon, usually without using any solvent. Reaction temperature may be from 120° C. to 280° C., and preferably from 150° C. to 250° C. Reaction time may preferably be from 1 hour to 15 hours.

The boric acid and boric anhydride may preferably be added to the reaction system after they have been mixed in advance. If only the boric acid is added, dehydration reaction or the like of the boric acid takes place undesirably. The mixture of the boric acid and boric anhydride may be added at a temperature of from 100° C. to 180° C., and preferably from 110° C. to 160° C. If it is added at a temperature of lower than 100° C., the catalytic function of the boric anhydride may lower undesirably, due to water content or the like remaining in the system.

After the reaction has been completed, water may be added to the reaction mixture, and the wax borate thus formed may be hydrolyzed, followed by purification to obtain the desired hydrocarbon wax.

As the aliphatic hydrocarbon, a saturated or unsaturated aliphatic hydrocarbon may be used which has a number-average molecular weight measured by gel permeation chromatography (GPC), within the range of from 100 to 3,000, preferably from 200 to 2,000, and more preferably from 250 to 1,000, in terms of polyethylene.

As the aliphatic hydrocarbon, preferably usable are, e.g., (A) a higher aliphatic unsaturated hydrocarbon having at least one double bond, obtained by polymerization of ethylene or by converting a petroleum hydrocarbon into an olefin by thermal decomposition, (B) a n-paraffin mixture obtained from a petroleum fraction, (C) a polyethylene wax obtained by polymerization of ethylene and (D) a higher aliphatic unsaturated hydrocarbon obtained by Fischer-Tropsch synthesis. Any of these compounds may be used or in combination.

The wax having a hydroxyl group in the present invention may preferably have a melting point of from 65° C. to 130° C., more preferably from 70° C. to 125° C., and still more preferably from 75° C. to 120° C. By using in the toner the wax having a melting point within the above range, the effect of the wax plasticizing the toner can be more improved, and the fixing performance of the toner can be made higher. Although high-temperature offset tends to occur as the plasticization of the resin proceeds, the hydrocarbon wax according to the present invention has superior releasability on account of the hydroxyl group and hence can maintain good high-temperature anti-offset properties. If the wax has a melting point of lower than 65° C., the toner may have low anti-offset properties. If it has a melting point of higher than 130° C., the effect of improving the fixing performance of the toner may be difficult to obtain.

The wax having a hydroxyl group in the present invention may also have a penetration at 25° C. of 15 or less, preferably 12 or less, and more preferably 10 or less. This is preferable in order for the toner to have higher charging performance and achieve higher developing performance even in a high-temperature and high-humidity environment. If the wax has a penetration at 25° C. of more than 15, the toner may have low anti-blocking properties. In the present invention, the penetration of the wax is determined according to JIS K 2235-5.4.

The wax having a hydroxyl group in the present invention may also have a viscosity at 120° C. of 500 mPa·s or less, preferably 200 mPa·s or less, and more preferably 100 mPa·s or less. This is preferable in view of such an advantage that the toner can be made to have a low viscosity and have a higher fixing performance. If it has a viscosity at 120° C. of more than 500 mPa·s, the toner may have insufficient fixing performance. In the present invention, the viscosity of the wax is determined according to JIS K 6862-7.2.

The wax having a hydroxyl group in the present invention may also have a softening point of from 65° C. to 140° C., preferably from 70° C. to 130° C., and more preferably from 75° C. to 120° C. This is preferable in view of such an advantage that the toner can achieve good fixing performance, anti-offset properties and anti-blocking properties. If the wax has a softening point of lower than 65° C., the toner may have low anti-blocking properties and anti-offset properties. If the wax has a softening point of higher than 140° C., the toner may have insufficient fixing performance. In the present invention, the softening point of the wax is determined according to JIS K 2207-6.4.

The wax having a hydroxyl group in the present invention may be added to the toner preferably in an amount of from 0.2 to 20 parts by weight, more preferably from 0.5 to 15 parts by weight, and still more preferably from 1 to 15 parts by weight, based on 100 parts by weight of the binder resin.

The wax having a hydroxyl group in the present invention may also be used in combination with any known wax commonly used in toner. For example, they may include paraffin wax and derivatives thereof, montan wax and derivatives thereof, microcrystalline wax and derivatives thereof, Fischer-Tropsch wax and derivatives thereof, polyolefin wax and derivatives thereof, and carnauba wax and derivatives thereof. The derivatives may include oxides, block copolymers with vinyl monomers, and graft-modified products.

Any of these waxes usable in combination may be used in an amount ranging from 0.2 to 20 parts by weight, preferably from 0.5 to 15 parts by weight, and more preferably from 1 to 15 parts by weight, based on 100 parts by weight of the binder resin.

The toner of the present invention may also preferably be incorporated with a charge control agent.

A charge control agent capable of controlling the toner to be negatively chargeable may include, e.g., organometallic complexes, chelate compounds and organometallic salts. Stated specifically, they may include monoazo metal complexes; and metal complexes or metal salts of aromatic hydroxycarboxylic acids and aromatic dicarboxylic acids. Besides, they may also include aromatic hydroxycarboxylic acids, aromatic mono- and polycarboxylic acids, and anhydrides or esters thereof; and phenolic derivatives such as bisphenol.

In particular, azo type metal complexes represented by the following formula (A) shown below are preferred.

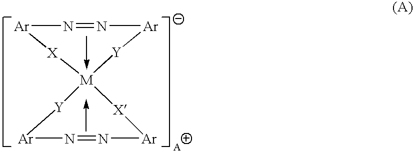

In the formula, M represents a central metal of coordination, as exemplified by Sc, Ti, V, Cr, Co, Ni, Mn or Fe. Ar represents an aryl group as exemplified by a phenyl group or a naphthyl group, which may have a substituent. In such a case, the substituent includes a nitro group, a halogen atom, a carboxyl group, an anilide group, an alkyl group having 1 to 18 carbon atoms and an alkoxyl group having 1 to 18 carbon atoms. X, X′, Y and Y′ each represent —O—, —CO—, —NH— or —NR— (R is an alkyl group having 1 to 4 carbon atoms). A⁺ represents a counter ion, and represents hydrogen, sodium, potassium, ammonium or aliphatic ammonium, or mixed ions of any of these.

As the central metal, Fe or Cr is particularly preferred. As the substituent, a halogen atom, an alkyl group or an anilide group is preferred.

Basic organic-acid metal complexes represented by the following formula (B) shown below are also preferable as charge control agents capable of providing negative chargeability.

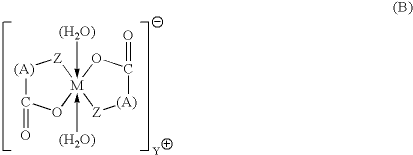

In the formula, M represents a central metal of coordination, as exemplified by Cr, Co, Ni, Mn, Fe, Zn, Al, Si or B. A represents;

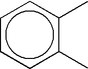

(which may have a substituent such as an alkyl group)

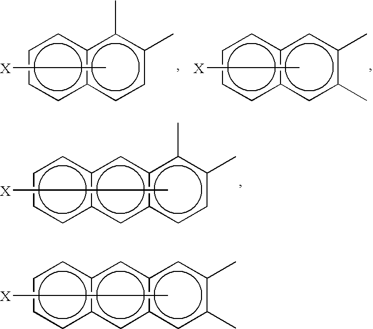

(X represents a hydrogen atom, a halogen atom, a nitro group or an alkyl group), and

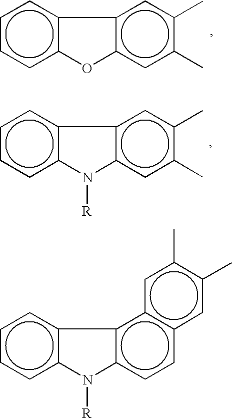

(R represents a hydrogen atom, an alkyl group having 1 to 18 carbon atoms or an alkenyl group having 2 to 16 carbon atoms);

Y⁺ represents a counter ion, and represents hydrogen, sodium, potassium, ammonium, aliphatic ammonium, or mixed ions of any of these. Z represents —O— or

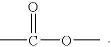

As the central metal, Fe, Cr, Si, Zn or Al is particularly preferred. As the substituent, an alkyl group, an anilide group, an aryl group or a halogen atom is preferred. As counter ions, hydrogen, ammonium or aliphatic ammonium is preferred.

A charge control agent capable of controlling the toner to be positively chargeable includes the following compounds.

Nigrosine and products modified with a fatty acid metal salt; quaternary ammonium salts such as tributylbenzylammonium 1-hydroxy-4-naphthosulfonate and tetrabutylammonium teterafluoroborate, and analogues of these, i.e., onium salts such as phosphonium salts, and lake pigments of these, triphenylmethane dyes and lake pigments of these (laking agents include tungstophosphoric acid, molybdophosphoric acid, tungstomolybdophosphoric acid, tannic acid, lauric acid, gallic acid, ferricyanic acid and ferrocyanic acid); metal salts of higher fatty acids; diorganotin oxides such as dibutyltin oxide, dioctyltin oxide and dicyclohexyltin oxide; diorganotin borates such as dibutyltin borate, dioctyltin borate and dicyclohexyltin borate; and guanidine compounds, and imidazole compounds. Any of these may be used alone or in combination of two or more kinds. Of these, triphenylmethane compounds and quaternary ammonium salts whose counter ions are not halogens may preferably be used. Homopolymers of monomers represented by the following formula (C);

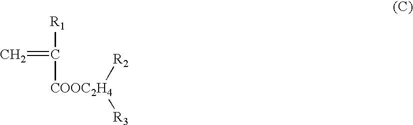

wherein R₁ represents hydrogen or methyl; R₂ and R₃ each independently represent a substituted or unsubstituted alkyl group (preferably having 1 to 4 carbon atoms);

or copolymers of polymerizable monomers such as styrene, acrylates or methacrylates as described above may also be used as positive charge control agents. In this case, these charge control agents can also act as binder resins (as a whole or in part).

In particular, a compound represented by the following formula (D) is particularly preferred as the positive charge control agent used in the present invention.

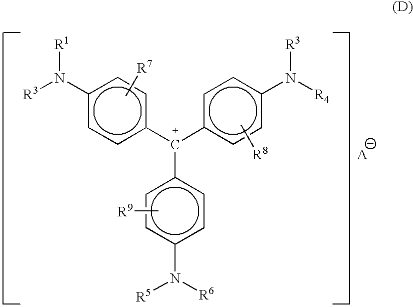

wherein R¹, R², R³, R⁴, R⁵ and R⁶ may be the same or different from one another and each represent a hydrogen atom, a substituted or unsubstituted alkyl group or a substituted or unsubstituted aryl group; R⁷, R⁸ and R⁹ may be the same or different from one another and each represent a hydrogen atom, a halogen atom, an alkyl group or an alkoxyl group; and A⁻ represents a negative ion selected from a sulfate ion, a nitrate ion, a borate ion, a phosphate ion, a hydroxide ion, an organic sulfate ion, an organic sulfonate ion, an organic phosphate ion, a carboxylate ion, an organic borate ion, or tetrafluorborate.

As methods for incorporating the toner with the charge control agent, there are a method of adding it internally into the toner particles and a method of adding it externally to the toner particles. The amount of the charge control agent used depends on the type of the binder resin, the presence or absence of any other additives, and the manner by which the toner is produced, including the manner of dispersion, and can not absolutely be specified. Preferably, the charge control agent may be used in an amount ranging from 0.1 to 10 parts by weight, and more preferably from 0.1 to 5 parts by weight, based on 100 parts by weight of the binder resin.

In the toner of the present invention, a magnetic material may be incorporated in toner particles so that the toner is used as a magnetic toner. In this case, the magnetic material may serve also as a colorant. The magnetic material used in the magnetic toner may include iron oxides such as magnetite, hematite and ferrite; and powders of metals such as iron, cobalt and nickel, or alloys and mixtures of any of these metals with a metal such as aluminum, cobalt, copper, lead, magnesium, tin, zinc, antimony, beryllium, bismuth, cadmium, calcium, manganese, selenium, titanium, tungsten or vanadium.

These magnetic materials may preferably be those having a number-average particle diameter of from 0.05 μm to 1.0 μm, and more preferably from 0.1 μm to 0.5 μm. Magnetic materials having a BET specific surface area of from 2 to 40 m²/g may preferably be used (more preferably from 4 to 20 m²/g). There are no particular limitations on their particle shape, and those having any desired shape may be used. As magnetic properties, preferably used are those having a saturation magnetization of from 10 to 200 Am²/kg (more preferably from 70 to 100 Am²/kg), a residual magnetization of from 1 to 100 Am²/kg (more preferably from 2 to 20 Am²/kg) and a coercive force of from 1 to 30 kA/m (more preferably from 2 to 15 kA/m) under application of a magnetic field of 795.8 kA/m. Any of these magnetic materials may be used in an amount of from 20 to 200 parts by weight, and preferably from 40 to 150 parts by weight, based on 100 parts by weight of the binder resin.

To determine the number-average particle diameter of the magnetic material, a photograph taken at a magnification on a transmission electron microscope may be measured with a digitizer. The magnetic properties of the magnetic material may be measured with a vibration sample magnetic-force meter VSM-3S-15 (manufactured by Toei Kogyo K.K.) under application of an external magnetic field of 795.8 kA/m. To measure the specific surface area of the magnetic material, nitrogen gas may be adsorbed on sample surfaces using a specific surface area measuring device AUTOSOBE 1 (manufactured by Yuasa Ionics Co.), and the specific surface area may be calculated by the BET multiple-point method.

As other colorants usable in the toner of the present invention, any suitable pigments and dyes may be used. The pigments may include carbon black, Aniline Black, acetylene black, Naphthol Yellow, Hanza Yellow, Rhodamine Lake, Alizarine Lake, red iron oxide, Phthalocyanine Blue and Indanethrene Blue. Any of these may be used in an amount necessary for maintaining optical density of fixed images, and may be added in an amount of from 0.1 to 20 parts by weight, and preferably from 0.2 to 10 parts by weight, based on 100 parts by weight of the binder resin. The dyes may include azo dyes, anthraquinone dyes, xanthene dyes and methine dyes, any of which may be added in an amount of from 0.1 to 20 parts by weight, and preferably from 0.3 to 10 parts by weight, based on 100 parts by weight of the binder resin.

To the toner of the present invention, an inorganic fine powder or a hydrophobic-treated inorganic fine powder may preferably externally be added. For example, it may include fine silica powder, fine alumina powder and fine titanium oxide powder, or hydrophobic-treated products of these. Any of these may be used alone or in combination.

The silica fine powder may include both of what is called dry-process silica or fumed silica produced by vapor phase oxidation of silicon halides and what is called wet-process silica produced from water glass or the like. The dry-process silica is more preferred, as having less silanol groups on the surface and inside and leaving no production residues.

It is also preferable for the inorganic fine powder to have been hydrophobic-treated. Such hydrophobic treatment may be carried out by treating the inorganic fine powder chemically with an organosilicon compound capable of reacting with or physically adsorbing the fine silica powder. As a preferred method, it may include a method in which the dry-process fine silica powder produced by vapor phase oxidation of a silicon halide is treated with a silane compound and thereafter, or at the same time it is treated with the silane compound, treated with an organosilicon compound such as silicone oil.

The silane compound (coupling agent) used for the hydrophobic treatment may include hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilane mercaptan, trimethylsilyl mercaptan, triorganosilyl acrylate, vinyldimethylacetoxysilane, dimethylethoxysilane, dimethyldimethoxysilane, diphenyldiethoxysilane, hexamethyldisiloxane, 1,3-divinyltetramethyldisiloxane, and 1,3-diphenyltetramethyldisiloxane.

The organosilicon compound may include silicone oils. As preferable silicone oils, those having a viscosity at 25° C. of approximately from 30 to 1,000 mm 2/s may be used. For example, dimethylsilicone oil, methylphenylsilicone oil, α-methylstyrene-modified silicone oil, chlorophenylsilicone oil and fluorine-modified silicone oil are preferred.

As methods for the treatment with silicone oil, the fine silica powder having been treated with the silane compound and the silicone oil may directly be mixed by means of a mixing machine such as a Henschel mixer, and a method may be used in which the silicone oil is sprayed on the fine silica powder serving as a base. Alternatively, the silicone oil may be dissolved or dispersed in a suitable solvent and thereafter mixed with the base fine silica powder, followed by removal of the solvent.

The above hydrophobic treatment or further treatment with oil in the fine silica powder may also be made on the fine titanium oxide powder and fine alumina powder. Such products are also preferable like the treated silica.

To the toner of the present invention, additives other than the fine silica powder, fine titanium oxide powder and fine alumina powder may optionally be added. For example, they are a charging auxiliary agent, a conductivity-providing agent, a fluidity-providing agent, a caking-preventive agent, a release agent at the time of heat roll fixing, a lubricant, and fine resin particles or inorganic fine particles which serve as an abrasive.

As the fine resin particles, those having an average particle diameter of from 0.03 to 1.0 μm are preferred. As a polymerizable monomer constituting the resin of such particles, it may include styrene; styrene derivatives such as o-methylstyrene, m-methylstyrene, p-methylstyrene, p-methoxystyrene and p-ethylstyrene; acrylic acid; methacrylic acid; acrylic esters such as methyl acrylate, ethyl acrylate, n-butyl acrylate, isobutyl acrylate, n-propyl acrylate, n-octyl acrylate, dodecyl acrylate, 2-ethylhexyl acrylate, stearyl acrylate, 2-chloroethyl acrylate and phenyl acrylate; methacrylic esters such as methyl methacrylate, ethyl methacrylate, n-propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate; and acrylonitrile, methacrylonitrile and acrylamide.

As methods for obtaining the fine resin particles, polymerization processes are preferred, which may include, e.g., suspension polymerization, emulsion polymerization and soap-free polymerization. Particles obtained by soap-free polymerization are more preferred.

Other fine particles may include lubricants such as fluorine resin, zinc stearate and polyvinylidene fluoride (in particular, polyvinylidene fluoride is preferred); abrasives such as cerium oxide, silicon carbide and strontium titanate (in particular, strontium titanate is preferred); fluidity-providing agents such as titanium oxide and aluminum oxide (in particular, hydrophobic ones are preferred); anti-caking agents; and conductivity-providing agents such as carbon black, zinc oxide, antimony oxide and tin oxide. In addition, white fine particles and black fine particles with a polarity reverse to that of the toner may also be used in a small quantity as developing performance improvers.

The resin fine particles, inorganic fine powder or hydrophobic inorganic fine powder mixed with the toner may be used in an amount of from 0.1 to 5 parts by weight, and preferably from 0.1 to 3 parts by weight, based on 100 parts by weight of the toner.

The toner of the present invention may preferably have a weight-average particle diameter (D4) of from 2.5 to 10 μm. This is preferable because an especially sufficient effect can be brought out within this range of particle diameter.

The weight-average particle diameter and particle size distribution of the toner is measured by the Coulter Counter method. Coulter Multisizer (manufactured by Coulter Electronics, Inc.) may be used. As an electrolytic solution, an aqueous 1% NaCl solution is prepared using first-grade sodium chloride. For example, ISOTON R-II (manufactured by Coulter Scientific Japan Co.) may be used. Measurement is carried out by adding as a dispersant 0.1 to 5 ml of a surface active agent (preferably an alkylbenzene sulfonate) to 100 to 150 ml of the above aqueous electrolytic solution, and further adding 2 to 20 mg of a sample to be measured. The electrolytic solution in which the sample has been suspended is subjected to dispersion for about 1 minute to about 3 minutes in an ultrasonic dispersion machine. The volume distribution and number distribution are calculated by measuring the volume and number of toner particles of 2.00 μm or more in diameter by means of the above measuring instrument, using an aperture of 100 μm as its aperture. Then, the weight-average particle diameter (D4) according to the present invention, determined from the volume distribution, is calculated. As channels, 13 channels are used, which are channels of 2.00 to less than 2.52 μmm, 2.52 to less than 3.17 μmm, 3.17 to less than 4.00 μmm, 4.00 to less than 5.04 μmm, 5.04 to less than 6.35 μmm, 6.35 to less than 8.00 μmm, 8.00 to less than 10.08 μmm, 10.08 to less than 12.70 μmm, 12.70 to less than 16.00 μmm, 16.00 to less than 20.20 μmm, 20.20 to less than 25.40 μmm, 25.40 to less than 32.00 μmm, and 32.00 to less than 40.30 μmm.

The toner of the present invention may be used in combination with a carrier so as to be used as a two-component developer. As the carrier used in two-component development, any of those conventionally known may be used. Stated specifically, surface-oxidized or -unoxidized particles having an average particle diameter of from 20 to 300 μm which are formed of metals such as iron, nickel, cobalt, manganese, chromium and rare earth elements and alloys or oxides of these are used as carrier particles.

The surfaces of the carrier particles may preferably be those to which a resin such as a styrene resin, an acrylic resin, a silicone resin, a fluorine resin or a polyester resin has been made to adhere, or those having been coated with any of these resins.

To produce the toner of the present invention, a method is preferable in which the toner constituent materials as described above are thoroughly mixed by means of a ball mill or other mixing machine, thereafter the mixture obtained is well kneaded by means of a heat kneading machine such as a heat roll, a kneader or an extruder and the kneaded product obtained is cooled to solidify, followed by mechanical pulverization and then classification to obtain toner particles. Besides, applicable are a polymerization method in which the stated materials are mixed with monomers which are to constitute the binder resin, to prepare an emulsion suspension, followed by polymerization to obtain toner particles; a method in which, in what is called a microcapsule toner comprised of a core material and a shell material, the core material or the shell material, or both of them, is/are incorporated with the stated materials; a method in which the constituent materials are dispersed in a binder resin solution, followed by spray drying to obtain toner particles. Any desired additives and the toner particles may further optionally thoroughly be mixed by means of a mixing machine such as a Henschel mixer to produce the toner of the present invention.

As the mixing machine, it may include, e.g., Henschel Mixer (manufactured by Mitsui Mining & Smelting Co.,.Ltd.); Super Mixer (manufactured by Kawata K.K.); Conical Ribon Mixer (manufactured by Ohkawara Seisakusho K.K.); Nauta Mixer, Turbulizer and Cyclomix (manufactured by Hosokawa Micron K.K.); Spiral Pin Mixer (manufactured by Taiheiyo Kiko K.K.); and Rhoedige Mixer (manufactured by Matsubo K.K.). As the kneading machine, it may include KRC Kneader (manufactured by Kurimoto Tekkosho K.K.); Buss-Kneader (manufactured by Buss Co.); TEM-type Extruder (manufactured by Toshiba Machine Co., Ltd.); TEX Twin-screw Extruder (manufactured by Nippon Seiko K.K.); PCM Kneader (manufactured by Ikegai Tekkosho K.K.); Three-Roll Mill, Mixing Roll Mill, and Kneader (manufactured by Inoue Seisakusho K.K.); Kneadex (manufactured by Mitsui Mining & Smelting Co., Ltd.); MS-type Pressure Kneader, Kneader-Ruder (manufactured by Moriyama Seisakusho K.K.); and Banbury Mixer (manufactured by Kobe Seikosho K.K.). As a grinding machine, it may include Counter Jet Mill, Micron Jet and Inomizer (manufactured by Hosokawa Micron K.K.); IDS-type Mill and PJM Jet Grinding Mill (manufactured by Nippon Pneumatic Kogyo K.K.); Cross Jet Mill (manufactured by Kurimoto Tekkosho K.K.); Ulmax (manufactured by Nisso Engineering K.K.); SK Jet O-Mill (manufactured by Seishin Kigyo K.K.); Criptron (manufactured by Kawasaki Heavy Industries, Ltd); Turbo Mill (manufactured by Turbo Kogyo K.K.); and Super Rotor (manufactured by Nisshin Engineering K.K.). As a classifier, it may include Classyl, Micron Classifier and Spedic Classifier (manufactured by Seishin Kigyo K.K.); Turbo Classifier (manufactured by Nisshin Engineering K.K.); Micron Separator, Turboprex (ATP) and TSP Separator (manufactured by Hosokawa Micron K.K.); Elbow Jet (manufactured by Nittestsu Kogyo K.K.); Dispersion Sparator (manufactured by Nippon Pneumatic Kogyo K.K.); and YM Microcut (manufactured by Yasukawa Shoji K.K.). As a sifter used to sieve coarse powder and so forth, it may include Ultrasonics (manufactured by Koei Sangyo K.K.); Rezona Sieve and Gyro Sifter (manufactured by Tokuju Kosakusho K.K.); Vibrasonic Sifter (manufactured by Dulton Co.); Sonicreen (manufactured by Shinto Kogyo K.K.); Turbo-Screener (manufactured by Turbo Kogyo K.K.); Microsifter (manufactured by Makino Sangyo K.K.); and circular vibrating screens.

Physical properties of the toner and its components according to the present invention are measured by the following methods.

(1) Molecular Weight Distribution of Toner and Raw-Material Resin:

In the present invention, the molecular weight distribution of the THF-soluble matter of the toner and raw-material resin is measured by GPC (gel permeation chromatography) under the following conditions.

Columns are stabilized in a heat chamber of 40° C. To the columns kept at this temperature, THF as a solvent is flowed at a flow rate of 1 ml per minute, and about 100 μl of a sample THF solution is injected thereinto to make measurement. In measuring the molecular weight of the sample, the molecular weight distribution ascribed to the sample is calculated from the relationship between the logarithmic value of a calibration curve prepared using several kinds of monodisperse polystyrene standard samples and the number of count. As the standard polystyrene samples used for the preparation of the calibration curve, it is suitable to use samples with molecular weights of from 100 to 10,000,000, which are available from, e.g., Tosoh Corporation or Showa Denko K.K., and to use at least about 10 standard polystyrene samples. An RI (refractive index) detector is also used as a detector. Columns should be used in combination of a plurality of commercially available polystyrene gel columns. For example, they may preferably comprise a combination of SHODEX GPC KF-801, KF-802, KF-803, KF-804, KF-805, KF-806, KF-807 and KF-800P, available from Showa Denko K.K.; or a combination of TSKgel G1000H(H_{XL}), G2000H(H_{X}L), G3000H(H_{XL}) G4000H(H_{XL}), G5000H(H_{XL}), G6000H(H_{XL}), G7000H(H_{XL}) and TSK guard column, available from Tosoh Corporation.

The THF sample solution is prepared in the following way.

The sample is put in THF, and is left for several hours, followed by thorough shaking so as to be well mixed with the THF (until coalescent matters of the sample has disappeared), which is further left for at least 12 hours. Here, the sample is so left as to stand in THF for at least 24 hours. Thereafter, the solution having been passed through a sample-treating filter (pore size: 0.2 to 0.5 μm; for example, MAISHORIDISK H-25-2, available from Tosoh Corporation may be used) is used as the sample for GPC. The sample is so adjusted as to have resin components in a concentration of from 0.5 to 5 mg/ml.

(2) Content of THF-Insoluble Matter

In the present invention, the THF-insoluble matter of the binder resin component in the toner and the THF-insoluble matter of the raw-material binder resin are measured in the following way.

The toner is weighed in an amount of from 1.0 to 2.0 g [W1 (g)], which is then put in a cylindrical filter paper (for example, No. 86R, available from Toyo Roshi K.K.) and set on a Soxhlet extractor. Extraction is carried out for 10 hours using 200 ml of THF as a solvent, and the soluble component solution extracted by the use of the solvent is evaporated, followed by vacuum drying at 100° C. for several hours. Then the THF-soluble resin component is weighed [W2 (g)].

Meanwhile, the weight of incineration residue ash content is also determined [W3 (g)] contained in the toner W1 (g) is determined in the following way: About 2.0 g of a sample is put in a 30 ml magnetic crucible weighed previously precisely, and the sample weight [Wa (g)] is precisely weighed. The crucible is put in an electric furnace, and is heated at about 900° C. for about 3 hours, followed by leaving to cool in the electric furnace, and then leaving to cool in a desiccator for 1 hour or longer at normal temperature, where the weight of the crucible is again precisely weighed. From this weight, the weight of the crucible is subtracted to determine the incineration residue ash content [Wb (g)]. From the relationship between Wb and Wa, the incineration residue ash content W3 (g) contained in the sample W1 (g) is represented by the following expression.

Incineration residue ash content W3 (g)=(Wb/Wa)×W1.

Therefore, the THF-insoluble matter is determined from the following expression.

THF-insoluble matter (% by weight)=[{W1−(W3+W2)}/(W1−W3)]×100.

In this expression for calculation, it follows that some part of the wax, charge control agent and so forth remains as a component included in the denominator or the numerator. However, their quantities are so small as to be negligible, and the value found by the calculation according to the above expression is regarded as the THF-insoluble matter in the present invention.

(3) Acid Value of Toner's THF-Soluble Matter and Raw-Material Binder Resin:

In the present invention, the acid value (JIS acid value) of the THF-soluble matter and raw-material binder resin of the toner is determined in the manner described below. The acid value of the raw-material binder resin means the acid value of the THF-soluble matter in the raw-material binder resin.

Basic operation is made according to JIS K-0070.

1) A sample is used after the THF-insoluble matter of the toner and raw-material binder resin has been removed, or the soluble component obtained in the above measurement of THF-insoluble matter, which has been extracted with THF solvent by means of the Soxhlet extractor, is used as a sample. A crushed product of the sample is precisely weighed in an amount of from 0.5 to 2.0 g, and the weight of the soluble component is represented by W (g).

2) The sample is put in a 300 ml beaker, and 150 ml of a toluene/ethanol (4/1) mixed solvent is added thereto to dissolve the sample.

3) Using an ethanol solution of 0.1 mol/l of KOH, titration is made by means of a potentiometric titrator. (For example, automatic titration may be utilized which is made using a potentiometric titrator AT-400, WIN WORKSTATION, manufactured by Kyoto Denshi K.K. and an ABP-410 motor burette.)

4) The amount of the KOH solution used here is represented by S (ml). A blank test not using any sample is also made at the same time, and the amount of the KOH solution used in the blank is represented by B (ml).

5) The acid value is calculated according to the following expression. Letter symbol f is the factor of KOH.

Acid value (mg·KOH/g)={(S−B)×f×5.61}/W.

(4) Glass Transition Temperature (Tg) of Toner:

The glass transition temperature (Tg) of the toner of the present invention is measured according to ASTM D3418-82, using a differential scanning calorimeter (DSC measuring instrument) DSC-7 (manufactured by Perkin-Elmer Corporation) or DSC2920 (manufactured by TA Instruments Japan Ltd.).

A sample for measurement is precisely weighed in an amount of 5 to 20 mg, and preferably 10 mg. This sample is put in a pan made of aluminum and an empty aluminum pan is used as reference. Measurement is made in a normal-temperature normal-humidity environment (25° C./60% RH) at a heating rate of 10° C./min within the temperature range of from 30° C. to 200° C. In this temperature rise process, the change of the specific heat is measured, and the intersection of the differential thermal curve and the center line between the base lines of the differential thermal curve before and after the occurrence of the change of the specific heat in the temperature range of 40° C. to 100° C., is regarded as the glass transition temperature (Tg) of the toner according to the present invention.

(5) Epoxy Value:

The epoxy value of the vinyl resin having an epoxy group is determined in the following way.

Basic operation is made according to JIS K-7236.

1) A sample is precisely weighed in an amount of from 0.5 to 2.0 g, and its weight is represented by W (g).

2) The sample is put in a 300 ml beaker, and is dissolved in a mixture of 10 ml of chloroform and 20 ml of acetic acid.

3) To the solution obtained in (2), 10 ml of tetraethylammonium bromide acetic acid solution (one prepared by dissolving 100 g of tetraethylammonium bromide in 400 ml of acetic acid) is added. Using a 0.1 mol/l perchloric acid acetic acid solution, titration is made by means of a potentiometric titrator. (For example, automatic titration may be utilized which is made using a potentiometric titrator AT-400, WIN WORKSTATION, manufactured by Kyoto Denshi K.K. and an ABP-410 motor burette.) The amount of the perchloric acid acetic acid solution used here is represented by S (ml). A blank not using any sample is measured at the same time, and the amount of the perchloric acid acetic acid solution used in the blank is represented by B (ml).

The epoxy value is calculated according to the following expression. Letter symbol f is the factor of the perchloric acid acetic acid solution.

Epoxy value (eq/kg)=0.1×f×(S−B)/W.

(6) Molecular Weight Distribution of Wax:

In the present invention, the molecular weight distribution of the wax is measured by gel permeation chromatography (GPC) under the following conditions.

(GPC Measurement Conditions)

Instrument: HLC-8121GPC/HT (manufactured by Tosoh Corporation).

Columns: Combination of two columns of TSKgel GMHHR-H HT, 7.8 cm I.D.×30 cm (available from Tosoh Corporation).

Detector: RI for high temperature.

Temperature: 135° C.

Solvent: o-Dichlorobenzene (0.05% ionol-added).

Flow rate: 1.0 ml/min.

Sample: 0.4 ml of a sample with concentration of 0.1% is injected.

Measurement is carried out under the conditions shown above. The molecular weight of the sample is calculated using a molecular-weight calibration curve prepared from a monodisperse polystyrene standard sample, and converted into polyethylene by a conversion equation derived from the Mark-Houwink viscosity equation.

(7) Acid Value, Hydroxyl Value, Ester Value and Saponification Value of Wax:

In the present invention, the acid value, hydroxyl value, ester value and saponification value of the wax are determined by the following methods. Basic operation is made according to JIS K-0070.

(Measurement of Acid Value)

Apparatus and instrument:

Erlenmeyer flask (300 ml).

Burette (25 ml).

Water bath or hot plate.

Reagent:

0.1 mol/liter Hydrochloric acid.

0.1 mol/liter Potassium hydroxide ethanol solution. (To make standardization, 25 ml of 0.1 mol/liter hydrochloric acid is taken in an Erlenmeyer flask by means of a whole pipette, and a phenolphthalein solution is added thereto to carry out titration with a 0.1 mol/liter potassium hydroxide ethanol solution, where the factor is determined from the quantity required for neutralization.)

Solvent of phenolphthalein solution. (A mixed solvent of diethyl ether and ethanol (99.5) in volume ratio of 1:1 or 2:1. These are added as an indicator in few drops immediately before use, and neutralized with the 0.1 mol/liter potassium hydroxide ethanol solution.)

Measurement:

(a) 1 to 20 g of the wax is precisely weighed in the Erlenmeyer flask.

(b) 100 ml of a solvent and few drops of the phenolphthalein solution as an indicator are added to the wax, and these are thoroughly mixed by shaking until the wax dissolves completely on the water bath.

(c) Titration is carried out with the 0.1 mol/liter potassium hydroxide ethanol solution, and the point in time from which the pale red color of the indicator has continued for 30 second is regarded as the end point.

Calculation:

A=5.611×B×f/S

where;

A: acid value (mg·KOH/g);

B: the quantity (ml) of the 0.1 mol/liter potassium hydroxide ethanol solution used in the titration;

f: the factor of the 0.1 mol/liter potassium hydroxide ethanol solution;

S: the weight (g) of the wax; and

5.611: the formular weight 56.11×1/10 of potassium hydroxide.

(Measurement of Hydroxyl Value)

Apparatus and instrument:

Measuring cylinder (100 ml).

Whole pipette (5 ml).

Flat-bottom flask (200 ml).

Glycerol bath.

Reagent:

Acetylating reagent. (25 g of acetic anhydride is taken in 100 ml of a whole flask, and pyridine is added to make the total volume 100 ml, followed by thorough mixing by shaking.)

Phenolphthalein solution.

0.5 mol/liter Potassium hydroxide ethanol solution.

Measurement:

(a) 0.5 to 6.0 g of the wax is precisely weighed in the flat-bottom flask, and 5 ml of the acetylating reagent is added by means of the whole pipette.

(b) A small funnel is placed on the mouth of the flask, and the flask is heated immersing its bottom by about 1 cm in the glycerol bath, kept at a temperature of from 95° C. to 100° C. In order to prevent the neck of the flask from being heated by the glycerol bath to become hot, a cardboard disk having a round hole made at its center is put on the base of the neck of the flask.

(c) After 1 hour, the flask is taken out of the glycerol bath, and then, after it was left to cool, 1 ml of water is added thereto from the funnel, followed by shaking to decompose the acetic anhydride.

(d) Further, in order to decompose it completely, the flask is again heated in the glycerol bath for 10 minutes, and then, after it was left to cool, the walls of the funnel and flask are washed with 5 ml of 95% ethanol.

(e) Few drops of the phenolphthalein solution are added as an indication, and then titration is carried out with the 0.5 mol/liter potassium hydroxide ethanol solution, and the point in time from which the pale red color of the indicator has continued for about 30 second is regarded as the end point.

(f) A blank test is made following the steps (a) to (e) but not adding any wax.

(g) Where the sample can not dissolve easily, pyridine is added in a small quantity, or xylene or toluene is added to effect dissolution.

Calculation:

A=[{(B−C)×28.05×f}/S]+D

where;

A: hydroxyl value (mg·KOH/g);

B: the quantity (ml) of the 0.5 mol/liter potassium hydroxide ethanol solution used in the blank test;

C: the quantity (ml) of the 0.5 mol/liter potassium hydroxide ethanol solution used in the titration;

f: the factor of the 0.5 mol/liter potassium hydroxide ethanol solution;

S: the weight (g) of the wax;

D: acid value; and

28.05: the formular weight 56.11×½ of potassium hydroxide.

(Measurement of Ester Value)

Calculated according to the following expression.

Ester value=(saponification value)−(acid value).

(Measurement of Saponification Value)

Apparatus and instrument:

Erlenmeyer flask (200 to 300 ml).

Air condenser. (A glass tube of 6 to 8 mm in outer diameter and 100 cm in length or a reflux condenser, either of which is one grindingly connectable to the mouth of the Erlenmeyer flask.)

Water bath, sand bath or hot plate. (One controllable to a temperature of about 80° C.)

Burette (50 ml).

Whole pipette (25 ml).

Reagent:

0.5 mol/liter Hydrochloric acid.

0.5 mol/liter Potassium hydroxide ethanol solution.

Phenolphthalein solution.

Measurement:

(a) 1.5 to 3.0 g of the wax is precisely weighed in the Erlenmeyer flask, up to a figure of 1 mg.

(b) 25 ml of the 0.5 mol/liter potassium hydroxide ethanol solution is added by means of the whole pipette.

(c) The air condenser is attached to the Erlenmeyer flask. Mixing the contents sometimes by shaking, they are gently heated on the water bath, sand bath or hot plate for 30 minutes to allow them to react. When heated, the heating temperature is so controlled that the circle of ethanol being reflux does not reach the upper end of the air condenser.

(d) After the reaction has been completed, the contents are immediately cooled, and then, before they solidify in agar, water or a xylene-ethanol 1:3 mixed solvent is sprayed in a small quantity from above the air condenser to wash its inner wall. Thereafter, the air condenser is detached.

(e) 1 ml of the phenolphthalein solution is added as an indicator, and then titration is carried out with the 0.5 mol/liter hydrochloric acid. The point in time from which the pale red color of the indicator has no longer come to appear for about 1 minute is regarded as the end point.

(f) A blank test is made following the steps (a) to (e) but not adding any wax.

(g) Where the sample can not dissolve easily, xylene or a xylene-ethanol mixed solvent is beforehand used to effect dissolution.

Calculation:

A={(B−C)×28.05×f}/S

where;

A: saponification value (mg·KOH/g);

B: the quantity (ml) of the 0.5 mol/liter hydrochloric acid used in the blank test;

C: the quantity (ml) of the 0.5 mol/liter hydrochloric acid used in the titration;

f: the factor of the 0.5 mol/liter hydrochloric acid;

S: the weight (g) of the wax;

28.05: the formular weight 56.11×½ of potassium hydroxide.

In the present invention, when the acid value, hydroxyl value, ester value and saponification value of the wax contained in the toner are measured, they may be measured after the wax has been separated from the toner, and according to the above measuring methods.

(8) Melting Point of Wax:

In the present invention, the melting point of the toner of the wax may be measured using a differential scanning calorimeter (DSC measuring instrument) DSC-7 (manufactured by Perkin-Elmer Corporation) or DSC-TA (manufactured by SEIKO Instruments Ltd.) and under the following conditions. Basically, it is measured according to ASTM D3418. Sample: 0.5 to 2 mg, and preferably 1 mg. Measurement: The sample is put in a pan made of aluminum and an empty aluminum pan is used as reference.

Temperature curve:

Heating I (20° C. to 180° C.; heating rate: 10° C./min.).

Cooling I (180° C. to 10C; cooling rate: 10° C./min.).

Heating II (10° C. to 180° C; heating rate: 10° C./min.)

In the above temperature curve, the endothermic peak temperature measured in Heating II is regarded as the melting point.

### EXAMPLES

The present invention is described below in greater detail by giving Examples. The present invention is by no means limited to these.

### Synthesis Examples of Wax

### Wax Synthesis Example 1

As a raw-material wax, 1,000 g of Fischer-Tropsch wax (number-average molecular weight Mn: 718; average number of carbon atoms: 50.5) was put into a cylindrical reactor made of glass. Blowing nitrogen gas thereinto at a low rate (3 liters/minute), the temperature was raised to 140° C. Then, 26.3 g (0.41 mole) of a mixed catalyst of boric acid and boric anhydride in a molar ratio of 1.45 was added. Thereafter, blowing air (21 liters/minute) and nitrogen (16 liters/minute) into the reactor, the reaction was carried out at 180° C. for 2.5 hours. After the reaction was completed, an equivalent weight of hot water (95° C.) was added to hydrolyze the reaction mixture. Thereafter, this was allowed to stand and the wax having come separated to the upper layer was collected. The wax collected was washed with water to obtain a wax 1.

The wax 1 had an acid value of 7.5 mg·KOH/g, a hydroxyl value of 49.2 mg·KOH/g, an ester value of 14.3 mg·KOH/g, a melting point of 87.3° C., a viscosity at 120° C. of 12.2 mPa·s, a penetration of 6, a softening point of 92.5° C. and an Mn of 610. These physical properties of the wax 1 are shown in Table 1.

### Wax Synthesis Example 2

A wax 2 (Mn: 680) was obtained in the same manner as in Wax Synthesis Example 1 except that 1,000 g of polyethylene wax (Mn: 780) was used as the raw-material wax and the reaction time was changed to 1 hour. Physical properties of the wax 2 are shown in Table 1.

### Wax Synthesis Example 3

A wax 3 (Mn: 300) was obtained in the same manner as in Wax Synthesis Example 1 except that 1,000 g of paraffin wax (Mn: 390) was used as the raw-material wax and the boric acid/boric anhydride mixed catalyst was added in an amount changed to 0.72 moles. Physical properties of the wax 3 are shown in Table 1.

### Wax Synthesis Example 4

A wax 4 (Mn: 2,100) was obtained in the same manner as in Wax Synthesis Example 1 except that 1,000 g of polyethylene wax (Mn: 2,500) was used as the raw-material wax, the boric acid/boric anhydride mixed catalyst was added in an amount changed to 0.22 moles and the reaction time was changed to 1.0 hour. Physical properties of the wax 4 are shown in Table 1.

### Wax Synthesis Example 5

A wax 5 (Mn: 620) was obtained in the same manner as in Wax Synthesis Example 1 except that 1,000 g of Fischer-Tropsch wax (Mn: 750) was used as the raw-material wax, the boric acid/boric anhydride mixed catalyst was added in an amount changed to 0.83 moles and the reaction time was changed to 3.0 hours. Physical properties of the wax 5 are shown in Table 1.

### Wax Synthesis Example 6

A wax 6 (Mn: 260) was obtained in the same manner as in Wax Synthesis Example 1 except that 1,000 g of polyethylene wax (Mn: 350) was used as the raw-material wax, the boric acid/boric anhydride mixed catalyst was added in an amount changed to 1.2 moles and the reaction time was changed to 3.0 hours. Physical properties of the wax 6 are shown in Table 1.

### Wax Synthesis Example 7

A wax 7 (Mn: 284) was obtained in the same manner as in Wax Synthesis Example 1 except that 1,000 g of paraffin wax (Mn: 305) was used as the raw-material wax and the boric acid/boric anhydride mixed catalyst was added in an amount changed to 0.44 moles. Physical properties of the wax 7 are shown in Table 1.

### Wax 8

An alcohol wax having an Mn of 600 and having hydroxyl groups at the terminals of the hydrocarbon chain was used as a wax 8. Physical properties of the wax 8 are shown in Table 1.

Production Example A-1 of
High-molecular-weight Component

(by weight)

| | | |
|---|---|---|
| Styrene | 83.0 | parts |
| n-Butyl acrylate | 14.8 | parts |
| Methacrylic acid | 2.2 | parts |
| 2,2-Bis(4,4-di-t-butylperoxycyclohexyl)propane | 0.8 | part |

In a four-necked flask, stirring 200 parts by weight of xylene, the inside of the container was sufficiently displaced with nitrogen gas, and then the temperature was raised to 120° C. Thereafter, the above components were dropwise added over a period of 4 hours. This was further retained for 10 hours under reflux of xylene, where the polymerization was completed, and the solvent was removed by distillation under reduced pressure. The resin thus obtained was designated as a high-molecular-weight component A-1. Physical properties of the resin obtained are shown in Table 2.

Production Examples A-2 to A-4 of High-Molecular-Weight Component

High-molecular-weight components A-2 to A-4 were obtained in the same manner as in Production Example A-1 except that the formulation used therein was changed as shown in Table 2. Physical properties of the resin obtained are shown in Table 2.

Production Example B-1 of
Vinyl Resin Having Carboxyl Group

(by weight)

| | | |
|---|---|---|
| High-molecular-weight component A-1 | 20 | parts |
| Styrene | 64.1 | parts |
| n-Butyl acrylate | 15.1 | parts |
| Methacrylic acid | 0.8 | parts |
| Di-t-butyl peroxide | 1.4 | parts |

200 parts by weight of xylene was heated to 200° C. Thereafter, of the above formulation, compounds except the high-molecular-weight component A-1 were dropwise added to the xylene over a period of 4 hours. This was further retained for 1 hour under reflux of xylene, where the polymerization was completed. Then, the high-molecular-weight component A-1 was added to the resulting xylene solution and was well mixed, and thereafter the solvent was removed under reduced pressure. The resin thus obtained was designated as a resin B-1. Physical properties of the resin obtained are shown in Table 3.

Production Examples B-2, B-3 and B-5 of Vinyl Resin Having Carboxyl Group

High-molecular-weight components B-2, B-3 and B-5 were obtained in the same manner as in Production Example B-1 except that the formulation used therein was changed as shown in Table 3. Physical properties of the resin obtained are shown in Table 3.

Production Example B-4 of Vinyl Resin Having No Carboxyl Group

A high-molecular-weight component B-4 was obtained in the same manner as in Production Example B-1 except that the formulation used therein was changed as shown in Table 3. Physical properties of the resin obtained are shown in Table 3.

Production Example C-1 of
Vinyl Resin Having Epoxy Group

(by weight)

| | | |
|---|---|---|
| Styrene | 78.6 | parts |
| n-Butyl acrylate | 20.2 | parts |
| Glycidyl methacrylate | 1.2 | parts |
| Di-t-butyl peroxide | 5 | parts |

In a four-necked flask, 200 parts by weight of xylene was put. The inside of the container was sufficiently displaced with nitrogen gas, and then the temperature was raised to 170° C. with stirring. Thereafter, the above components were dropwise added over a period of 4 hours. This was further retained under reflux of xylene, where the polymerization was completed, and the solvent was removed by distillation under reduced pressure. The resin thus obtained was designated as a resin C-1. Physical properties of the resin obtained are shown in Table 4.

Production Example C-2 of Vinyl Resin Having Epoxy Group

A high-molecular-weight component C-2 was obtained in the same manner as in Production Example C-1 except that the formulation used therein was changed as shown in Table 4. Physical properties of the resin obtained are shown in Table 4.

### Example 1

90 parts by weight of the vinyl resin having carboxyl group, B-1, and 10 parts by weight of the vinyl resin having epoxy group, C-1, were mixed by means of a Henschel mixer. Thereafter, the mixture obtained was kneaded at 180° C. by means of a twin-screw extruder. The resulting kneaded product was cooled and thereafter pulverized to obtain a binder resin 1.

| | (by weight) | |
|---|---|---|
| The above binder resin 1 | 100 | parts |
| Spherical magnetic iron oxide (average particle | 95 | parts |
| diameter: 0.21 μm; magnetic properties in magnetic | | |
| field of 1 kilooerstead, or: 5.1 Am²/kg and σs: 69.6 | | |
| Am²/kg) | | |
| Wax 1 | 6 | parts |
| Negative chargeability control agent (an iron azo | 2 | parts |
| compound T-77, available from Hodogaya Chemical Co., | | |
| Ltd.) | | |

The above materials were sufficiently premixed by means of a Henschel mixer, and thereafter the mixture formed was melt-kneaded by means of a twin-screw extruder heated to 130° C. The kneaded product obtained was cooled and then crushed by means of a hammer mill. The resulting crushed product was then finely pulverized using a jet mill. The pulverized product obtained was subjected to air classification to obtain toner particles with a weight-average particle diameter (D4) of 6.9 μm.

To 100 parts by weight of the toner particles thus obtained, 1.2 parts by weight of hydrophobic-treated fine silica powder having been treated with hexamethyldisilazane and thereafter with dimethylsilicone oil (BET specific surface area of base particles: 200 m²/g) was externally added by dry-process mixing to obtain a toner 1. The formulation of the toner 1 obtained are shown in Table 5, and its physical properties in Table 6.

The acid value of the toner thus obtained was measured to ascertain that the acid value was 5.6 mg·KOH/g and carboxyl groups were present. The epoxy value thereof was also measured, where the epoxy value was found to have lowered and the carboxyl value was also found to have lowered, from which it was ascertained that carboxyl groups had reacted with epoxy groups and also ascertained that the resin had linkages formed by the reaction of carboxyl groups with epoxy groups. Incidentally, the like facts were ascertained also in Examples given below.

### Examples 2 to 6

Toners 2 to 6 were obtained in the same manner as in Example 1 except that in place of the wax 1 the waxes 2 to 5 and 8, respectively, were used. The formulation of the toners 2 to 6 obtained are shown in Table 5, and their physical properties in Table 6.

### Example 7

A toner 7 was obtained in the same manner as in Example 4 except that in place of the vinyl resin having carboxyl group, B-1, and the vinyl resin having epoxy group, C-1, the vinyl resin B-2 and the vinyl resin C-2, respectively, were used. The formulation of the toner 7 is shown in Table 5, and its physical properties in Table 6.

### Example 8

A toner 8 was obtained in the same manner as in Example 4 except that in place of the vinyl resin having carboxyl group, B-1, and the vinyl resin having epoxy group, C-1, the vinyl resin B-3 and the vinyl resin C-2, respectively, were used and the kneading temperature 180° C. of the twin-screw extruder was changed to 200° C. The formulation of the toner 8 is shown in Table 5, and its physical properties in Table 6.

### Example 9

A toner 9 was obtained in the same manner as in Example 8 except that in place of the wax 4 the wax 2 was used. The formulation of the toner 9 is shown in Table 5, and its physical properties in Table 6.

### Comparative Example 1

A toner 10 was obtained in the same manner as in Example 7 except that in place of the wax 4 the wax 6 was used. The formulation of the toner 10 is shown in Table 5, and its physical properties in Table 6.

### Comparative Example 2

A toner 11 was obtained in the same manner as in Example 7 except that in place of the wax 4 the wax 7 was used. The formulation of the toner 11 is shown in Table 5, and its physical properties in Table 6.

### Comparative Example 3

A toner 12 was obtained in the same manner as in Example 6 except that in place of the vinyl resin having carboxyl group, B-1, the vinyl resin having,no carboxyl group, B-4, was used. The formulation of the toner 12 is shown in Table 5, and its physical properties in Table 6.

### Comparative Example 4

A toner 13 was obtained in the same manner as in Example 4 except that in place of the binder resin 1 only the vinyl resin having carboxyl group, B-1, was used. The formulation of the toner 13 is shown in Table 5, and its physical properties in Table 6.

### Comparative Example 5

A toner 14 was obtained in the same manner as in Example 8 except that in place of the wax 4 the wax 7 was used. The formulation of the toner 14 is shown in Table 5, and its physical properties in Table 6.

### Comparative Example 6

A toner 15 was obtained in the same manner as in Example 6 except that in place of the vinyl resin having carboxyl group, B-1, the vinyl resin B-5 was used. The formulation of the toner 15 is shown in Table 5, and its physical properties in Table 6.

### Comparative Example 7

A toner 16 was obtained in the same manner as in Example 4 except that in place of the vinyl resin having carboxyl group, B-1, the vinyl resin B-5 was used. The formulation of the toner 16 is shown in Table 5, and its physical properties in Table 6.

Using the toners produced in the above Examples 1 to 9 and Comparative Examples 1 to 7, the following evaluation was made. The results of the evaluation are shown in Table 7.

(Evaluation)

-Print Tests-

Print tests were conducted using a commercially available laser beam printer LASER JET 9000 (manufactured by Hewlett-Packard) (50 sheets/minute in A4-paper crosswise feed; process speed: 235 mm/second). Into the process cartridge of the printer, 1,500 g of the toner was filled, which was then left for a day in evaluation environment to make the toner adjust to humidity and temperature, and thereafter images were printed. The images formed were evaluated on the following items.

(1) Image Density:

In a normal-temperature and normal-humidity environment (25° C., 60% RH) and a high-temperature and high-humidity environment (32.5° C., 80% RH), images were printed on usual plain paper for copying machines (basis weight: 75 g/m²) in the number of 30,000 sheets in total in continuous 3 days at a pace of 10,000 sheets/day. Evaluation was made on solid-black image density at the initial stage (1st sheet on the 1st day) and on the 10,000th sheet, the 20,000th sheet and the 30,000th sheet (in the normal-temperature and normal-humidity environment, only at the initial stage and on the 30,000th sheet). Images were reproduced in extensive operation (running) in an intermittent mode where a lattice pattern of 5% in print area percentage was printed on two sheets and thereafter the printing was paused for two seconds except the time that the images are checked. Here, the image density was measured with MACBETH REFLECTION DENSITOMETER (manufactured by Macbeth Co.), as relative density in respect to a printed image of white background area having a density of 0.00 as an original.

(2) Fog:

In respect of solid-white areas after 20,000-sheet image reproduction in a high-temperature and high-humidity environment (32.5° C., 80% RH), fog was calculated from a difference between the whiteness of a transfer paper before printing and the whiteness of a transfer paper after printing which were measured with REFLECTOMETER (manufactured by Tokyo Denshoku K.K.). As the transfer paper, usual plain paper for copying machines (basis weight: 75 g/m²) was used.

(3) Fixing Performance:

Fixing performance was evaluated using plain paper for copying machines (basis weight: 90 g/m²) Images printed immediately after initial start of the laser beam printer in a low-temperature and low-humidity environment (10° C., 15% RH) were rubbed with gentle paper under a pressure of 4.9 kPa. Fixing performance was evaluated by the percentage (%) of decrease in image density before and after the rubbing. Here, the toner's laid-on quantity was 5 g/m².

A: Less than 2%.

B: From 2% to less than 4%.

C: From 4% to less than 8%.

D: From 8% to 12%.

E: More than 12%.

(4) Anti-Offset Properties:

A sample image of about 5% in image area percentage was printed on A4-size sheets of paper as transfer materials in a high-temperature and high-humidity environment (32.5° C., 80% RH). Thereafter, one sheet of paper was fed through, where the anti-offset properties were evaluated by the extent of any contamination of the image. As the transfer material, usual plain paper for copying machines (basis weight: 64 g/m²) was used.

A: No contamination.

B: The image stands contaminated in careful review.

C: Offset has occurred, but in an extent not serious to look at.

D: Offset has occurred clearly.

(5) Anti-Blocking Properties:

10 g of the toner was weighed out in a cup made of polypropylene, and its surface was flatened. Thereafter, wrapping paper for powdered medicine was spread thereon, and then 10 g of an iron powder carrier was put thereon. This was left for 5 days in an environment of 50° C. and 0% RH, and then the state of blocking of the toner was examined to make evaluation.

A: The toner flows freely when the cup is inclined.

B: When the cup is turned, the toner surface begins to collapse to become free-flowing powder.

C: When a force is externally applied turning the cup, the toner surface collapses to begin to flow freely before long.

D: Blocking balls form. They collapse when picked with something sharp.

E: Blocking balls form. They can not collapse easily even when picked.

(6) Melt Adhesion to Sleeve:

In an environment of 35° C. and 80% RH, a lattice pattern of 5% in print area percentage was printed on 30,000 sheets by continuous printing where in-machine temperature rise came under severe conditions, and any melt adhesion (of toner) to sleeve (developing sleeve) was examined to make evaluation. Here, the in-machine temperature around the developing assembly was 48° C. to 50° C. Where the toner has melt adhered to the sleeve, the image density lowers or printed images come to have blank areas. Images at printing were checked on demand during the extensive operation, and whether or not the melt adhesion to sleeve occurs during the 30,000-sheet extensive operation was examined to make evaluation. Incidentally, after it occurred, the sleeve was cleaned and the extensive operation was again started. Also, whether or not the melt adhesion occurred was checked also when the sleeve was cleaned after the extensive operation.

A: Any melt adhesion to sleeve has not occur.

B: Although not affect images, the melt adhesion to sleeve has occurred.

C: At the stage of 20,000-sheet to 30,000-sheet printing, a decrease in image density has occurred because of the melt adhesion to sleeve.

D: At the stage of less than 20,000-sheet printing, a decrease in image density has occurred because of the melt adhesion to sleeve.

(7) Melt Adhesion to Photosensitive Member:

Images were printed on 30,000 sheets in the high-temperature and high-humidity environment. Solid-black images were printed after printing on 10,000 sheets, 20,000 sheets and 30,000 sheets. Whether or not any white dots appeared on images due to any melt adhesion of the toner to the photosensitive member was examined to make evaluation on melt adhesion to photosensitive member (drum).

A: Any melt adhesion to drum does not occur throughout the extensive operation.

B: Melt adhesion to drum occurs in 20,001- to 30,000-sheet extensive operation.

C: Melt adhesion to drum occurs in 10,001- to 20,000-sheet extensive operation.

D: Melt adhesion to drum occurs in extensive operation on less than 10,000 sheets.

TABLE 1
Wax Physical Properties

| | Hydroxyl | | | Melting | | Viscosity | Softening |
|---|---|---|---|---|---|---|---|
| | value | Ester value | Acid value | point | Pene- | at 120° C. | point |
| | (mg · KOH/g) | (mg · KOH/g) | (mg · KOH/g) | (° C.) | tration | (mPa · s) | (° C.) |
| Wax 1: | 49.2 | 14.3 | 7.5 | 87.3 | 6.0 | 12.2 | 92.5 |
| Wax 2: | 27.6 | 11.7 | 4.2 | 105.6 | 3.0 | 16.5(*1) | 108.9 |
| Wax 3: | 86.2 | 12.5 | 6.3 | 76.3 | 8.0 | 8.2 | 79.7 |
| Wax 4: | 11.7 | 6.5 | 2.3 | 111.2 | 1.0 | 23.0(*1) | 115.6 |
| Wax 5: | 105.6 | 32.4 | 18.3 | 82.9 | 9.0 | 10.5 | 84.7 |
| Wax 6: | 164.2 | 28.8 | 37.2 | 64.5 | 14.0 | 5.1 | 75.0 |
| Wax 7: | 3.1 | 51.9 | 35.7 | 68.3 | 12.0 | 7.4 | 71.9 |
| Wax 8: | 83.5 | 0.0 | 0.0 | 99.7 | 2.0 | 13.6 | 104.3 |

*1 Viscosity at 135° C.

TABLE 2
Formulation and Analytical Values of High-Molecular-Weight Component

| | Formulation | | | | | | | | Acid |
|---|---|---|---|---|---|---|---|---|---|
| | (part(s) by weight) | | | | | GPC | | | value |
| | St | BA | MA | AA | BPCP | Mw | Mn | Peak | (mg · KOH/g) |
| High-molecular- | | | | | | | | | |
| weight | | | | | | | | | |
| component: | | | | | | | | | |
| A-1 | 83.0 | 14.8 | 2.2 | — | 0.8 | 310,000 | 80,000 | 240,000 | 14.7 |
| A-2 | 84.5 | 14.6 | 0.9 | — | 0.7 | 360,000 | 92,000 | 270,000 | 5.8 |
| A-3 | 74.2 | 18.2 | — | 7.6 | 1 | 260,000 | 65,000 | 180,000 | 59.1 |
| A-4 | 86.5 | 13.5 | — | — | 0.6 | 390,000 | 110,000 | 290,000 | 0.0 |

St: Styrene, BA: n-Butyl acrylate, MA: Methacrylic acid, AA: Acrylic acid, BPCP: 2,2-Bis(4,4-di-t-butylperoxycyclohexyl)propane

TABLE 3
Physical Properties of Vinyl Resin

| | High = | | | | | | | | | | | | |
|---|---|---|---|---|---|---|---|---|---|---|---|---|---|
| | molecular = | | | | | | | GPC | | | | | |
| | weight | | Formulation | | | | | | | | High = | Acid | |
| | component | | (part(s) by weight) | | | | | | | Main | molecular | Acid value | Tg |
| | (pbw) | | St | BA | MA | AA | DTBP | Mw | Mn | peak | side peak | (mg · KOH/g) | (° C.) |
| Vinyl | | | | | | | | | | | | | |
| resin: | | | | | | | | | | | | | |
| B-1 | A-1 | 20.0 | 64.1 | 15.1 | 0.8 | — | 1.4 | 70,000 | 7,500 | 13,000 | 200,000 | 7.1 | 58.1 |
| B-2 | A-2 | 20.0 | 62.8 | 17.2 | 0.1 | — | 1.1 | 120,000 | 9,600 | 17,000 | 210,000 | 1.8 | 59.2 |
| B-3 | A-3 | 20.0 | 62.4 | 13.6 | — | 4.0 | 1.5 | 150,000 | 8,000 | 11,000 | 120,000 | 31.7 | 55.2 |
| B-4 | A-4 | 50.0 | 40.0 | 10.0 | — | — | 1.0 | 130,000 | 6,000 | 12,000 | 290,000 | 0.0 | 61.5 |
| B-5 | A-3 | 30.0 | 57.0 | 13.0 | — | — | 1.0 | 180,000 | 8,800 | 15,000 | 150,000 | 1.0 | 60.2 |

St: Styrene, BA: n-Butyl acrylate, MA: Methacrylic acid, AA: Acrylic acid, DTBP: Di-t-butyl peroxide

TABLE 4
Physical Properties of Vinyl Resin Having Epoxy Group

| | Formulation | | | | | | Epoxy |
|---|---|---|---|---|---|---|---|
| | (part(s) by weight) | | | | GPC | | value |
| | St | BA | GlyMA | DTBP | Mw | Mn | (eq/kg) |
| Vinyl | | | | | | | |
| resin: | | | | | | | |
| C-1 | 75.2 | 18.2 | 5.6 | 5.0 | 7,800 | 6,500 | 0.4 |
| C-2 | 64.3 | 11.5 | 14.2 | 5.0 | 6,900 | 5,800 | 1.0 |

St: Styrene, BA: n-Butyl acrylate, GlyMA: Glycidyl methacrylate, DTBP: Di-t-butyl peroxide

TABLE 5
Formulation of Toner

| | | Binder resin | | | | | Hydrocarbon wax | | Resin acid |
|---|---|---|---|---|---|---|---|---|---|
| | | | Resin | Resin | | | | Hydroxyl | value/wax |
| | | | com- | com- | | Acid value | | value | hydroxyl |
| | | Type | ponent B | ponent C | B/C | (mg · KOH/g) | Type | (mg · KOH/g) | value |
| Example: | | | | | | | | | |
| 1 | Toner 1 | Resin 1 | B-1 | C-1 | 90/10 | 6.7 | 1 | 49.2 | 0.136 |
| 2 | Toner 2 | Resin 1 | B-1 | C-1 | 90/10 | 6.6 | 2 | 27.6 | 0.239 |
| 3 | Toner 3 | Resin 1 | B-1 | C-1 | 90/10 | 6.8 | 3 | 86.2 | 0.079 |
| 4 | Toner 4 | Resin 1 | B-1 | C-1 | 90/10 | 6.7 | 4 | 11.7 | 0.573 |
| 5 | Toner 5 | Resin 1 | B-1 | C-1 | 90/10 | 6.9 | 5 | 105.6 | 0.065 |
| 6 | Toner 6 | Resin 1 | B-1 | C-1 | 90/10 | 6.5 | 8 | 83.5 | 0.078 |
| 7 | Toner 7 | Resin 2 | B-2 | C-2 | 90/10 | 1.6 | 4 | 11.7 | 0.137 |
| 8 | Toner 8 | Resin 3 | B-3 | C-1 | 90/10 | 31.0 | 4 | 11.7 | 2.66 |
| 9 | Toner 9 | Resin 3 | B-3 | C-1 | 90/10 | 31.1 | 2 | 27.6 | 1.13 |
| Comparative | | | | | | | | | |
| Example: | | | | | | | | | |
| 1 | Toner 10 | Resin 2 | B-2 | C-2 | 90/10 | 1.5 | 6 | 164.2 | 0.006 |
| 2 | Toner 11 | Resin 2 | B-2 | C-2 | 90/10 | 1.6 | 7 | 3.1 | 0.355 |
| 3 | Toner 12 | Resin 4 | B-4 | C-1 | 90/10 | 0.0 | 4 | 11.7 | 0.000 |
| 4 | Toner 13 | Resin — | B-1 | — | 100/0 | 7.1 | 4 | 11.7 | 0.607 |
| 5 | Toner 14 | Resin 3 | B-3 | C-1 | 90/10 | 31.2 | 7 | 3.1 | 10.1 |
| 6 | Toner 15 | Resin 5 | B-5 | C-1 | 90/10 | 0.8 | 8 | 83.5 | 0.010 |
| 7 | Toner 16 | Resin 5 | B-5 | C-1 | 90/10 | 0.8 | 4 | 11.7 | 0.068 |

TABLE 6
Toner Physical Properties

| | GPC | | | | THF-insoluble | Acid value |
|---|---|---|---|---|---|---|
| | | | Main | Tg | matter | (mg · |
| | Mw | Mn | peak | (° C.) | (% by weight) | KOH/g) |
| Example: | | | | | | |
| 1 | 76,000 | 6,000 | 11,000 | 56.6 | 16.2 | 5.6 |
| 2 | 79,000 | 6,200 | 13,000 | 57.0 | 15.8 | 5.4 |
| 3 | 74,000 | 5,900 | 10,000 | 56.4 | 14.6 | 5.5 |
| 4 | 72,000 | 5,700 | 10,700 | 56.3 | 16.6 | 5.7 |
| 5 | 71,000 | 5,800 | 11,200 | 56.5 | 15.5 | 5.5 |
| 6 | 79,000 | 6,100 | 12,000 | 56.6 | 15.0 | 5.6 |
| 7 | 107,000 | 7,800 | 18,000 | 55.3 | 8.0 | 1.4 |
| 8 | 123,000 | 7,500 | 8,300 | 55.7 | 19.8 | 23.7 |
| 9 | 126,000 | 7,200 | 8,000 | 56.0 | 19.5 | 25.3 |
| Com- | | | | | | |
| parative | | | | | | |
| Example: | | | | | | |
| 1 | 113,000 | 7,800 | 8,700 | 56.3 | 9.0 | 1.1 |
| 2 | 98,000 | 7,100 | 9,000 | 55.3 | 7.0 | 1.3 |
| 3 | 120,000 | 5,200 | 8,800 | 56.7 | 0.0 | 0.0 |
| 4 | 87,000 | 6,700 | 12,000 | 58.4 | 2.0 | 6.0 |
| 5 | 125,000 | 7,300 | 8,600 | 55.8 | 19.0 | 26.8 |
| 6 | 170,000 | 8,000 | 13,000 | 57.2 | 15.4 | 0.72 |
| 7 | 172,000 | 8,200 | 13,500 | 57.6 | 15.7 | 0.70 |

TABLE 7
Evaluation Results

| | Image density | | | | | | | Fixing | | | | |
|---|---|---|---|---|---|---|---|---|---|---|---|---|
| | Normal temp./ | | | | | | | per- | | Anti = | Melt | |
| | normal humid. | | High temp./high humid. | | | | | form- | Anti = | block- | adhesion to: | |
| | (I) | (3) | (I) | (1) | (2) | (3) | Fog | ance | offset | ing | Sleeve | Drum |
| Example: | | | | | | | | | | | | |
| 1 | 1.52 | 1.48 | 1.53 | 1.48 | 1.47 | 1.46 | 1.2 | A | A | A | A | A |
| 2 | 1.51 | 1.48 | 1.49 | 1.47 | 1.47 | 1.47 | 1.3 | A | A | A | A | A |
| 3 | 1.5 | 1.47 | 1.47 | 1.47 | 1.46 | 1.44 | 1.5 | A | A | A | A | A |
| 4 | 1.51 | 1.49 | 1.48 | 1.47 | 1.45 | 1.45 | 2.1 | B | A | B | A | C |
| 5 | 1.51 | 1.45 | 1.46 | 1.43 | 1.43 | 1.41 | 2.2 | A | B | B | A | C |
| 6 | 1.51 | 1.45 | 1.46 | 1.44 | 1.43 | 1.40 | 2.4 | C | C | B | B | A |
| 7 | 1.53 | 1.45 | 1.51 | 1.47 | 1.44 | 1.41 | 2.0 | A | B | B | A | C |
| 8 | 1.51 | 1.46 | 1.46 | 1.43 | 1.43 | 1.43 | 1.9 | B | A | B | A | C |
| 9 | 1.5 | 1.47 | 1.47 | 1.45 | 1.45 | 1.45 | 1.9 | B | A | B | A | C |
| Comparative | | | | | | | | | | | | |
| Example: | | | | | | | | | | | | |
| 1 | 1.47 | 1.41 | 1.35 | 1.21 | 1.13 | 1.02 | 3.8 | B | D | D | C | D |
| 2 | 1.48 | 1.4 | 1.31 | 1.32 | 1.24 | 1.12 | 4.1 | B | C | D | D | A |
| 3 | 1.52 | 1.46 | 1.45 | 1.43 | 1.38 | 1.30 | 2.3 | C | C | B | C | C |
| 4 | 1.52 | 1.47 | 1.46 | 1.38 | 1.37 | 1.35 | 3.4 | D | C | B | C | C |
| 5 | 1.47 | 1.42 | 1.42 | 1.41 | 1.4 | 1.37 | 3.0 | C | C | D | C | D |
| 6 | 1.51 | 1.45 | 1.47 | 1.44 | 1.35 | 1.21 | 2.6 | C | B | B | C | C |
| 7 | 1.53 | 1.47 | 1.46 | 1.43 | 1.33 | 1.19 | 2.3 | B | B | B | C | C |

(I): Initial stage
(1): On 10,000th sheet
(2): On 20,000th sheet
(3): On 30,000th sheet

What is claimed is:

1. A toner comprising toner particles containing at least a binder resin and a hydrocarbon wax, wherein;
said binder resin contains at least a vinyl resin having a carboxyl group and a vinyl resin having as a partial structure a linkage formed by reaction of a carboxyl group with an epoxy group;
said binder resin has an acid value Av_{B} of from 1 mg·KOH/g to 50 mg·KOH/g;
said hydrocarbon wax has a hydroxyl value Hv of from 5 mg·KOH/g to 150 mg·KOH/g; and
the acid value Av_{B} of said binder resin and the hydroxyl value Hv of said hydrocarbon wax satisfy the following expression:
0.05≦Av_{B}/Hv≦3.5.

2. The toner according to claim 1, wherein said hydrocarbon wax has an ester value Ev of from 1 mg·KOH/g to 50 mg·KOH/g, and has the hydroxyl value Hv and the ester value Ev in the relationship of:
Hv>Ev.

3. The toner according to claim 2, wherein the ester value Ev of said hydrocarbon wax is from 1 mg·KOH/g to 15 mg·KOH/g.

4. The toner according to claim 2, wherein said hydrocarbon wax satisfies:
Hv>2×Ev.

5. The toner according to claim 1, wherein said hydrocarbon wax has an acid value Av of from 1 mg·KOH/g to 30 mg·KOH/g.

6. The toner according to claim 5, wherein said hydrocarbon wax has the hydroxyl value Hv and the acid value Av in the relationship of:
Hv>Av.

7. The toner according to claim 6, wherein said hydrocarbon wax satisfies:
Hv>2×Av.

8. The toner according to claim 1, wherein said hydrocarbon wax has an ester value Ev of from 1 mg·KOH/g to 15 mg·KOH/g and has an acid value Av of from 1 mg·KOH/g to 30 mg·KOH/g.

9. The toner according to claim 1, which has a number-average molecular weight Mn of from 1,000 to 40,000 and a weight-average molecular weight Mw of from 10,000 to 10,000,000, in molecular weight distribution measured by gel permeation chromatography of tetrahydrofuran-soluble matter in the toner.

10. The toner according to claim 1, which has a main peak in the region of molecular weight of from 4,000 to 30,000, in molecular weight distribution measured by gel permeation chromatography of tetrahydrofuran-soluble matter in the toner.

11. The toner according to claim 1, wherein said binder resin contains a tetrahydrofuran-insoluble matter in an amount of from 0.1% by weight to 60% by weight.

12. The toner according to claim 1, wherein said binder resin has an acid value Av_{B} of from 2 mg·KOH/g to 40 mg·KOH/g.

13. The toner according to claim 1, wherein said hydrocarbon wax has a melting point of from 65° C. to 130° C.

14. The toner according to claim 1, wherein said hydrocarbon wax has the following partial structural formulas (A) and (B):

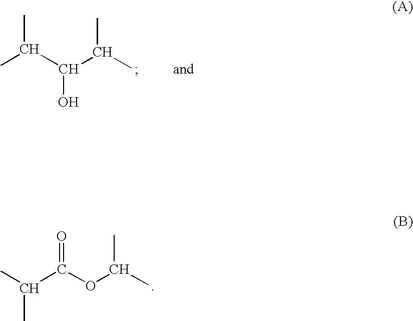

15. The toner according to claim 1, wherein said hydrocarbon wax contains components having the following partial structural formulas (C) and (D):

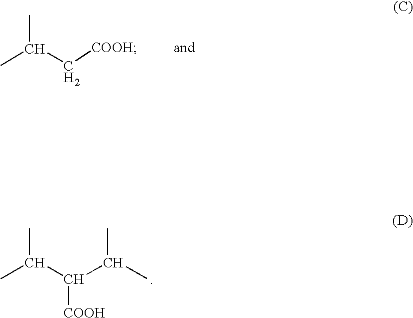

16. The toner according to claim 1, wherein said hydrocarbon wax contains a component having the following partial structural formula (E):

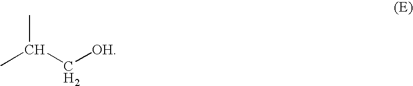

17. The toner according to claim 1, wherein said hydrocarbon wax is contained in an amount of from 0.5 part by weight to 15 parts by weight based on 100 parts by weight of the binder resin.
